(19) United States
(12) Patent Application Publication
(10) Pub. No.: US 2026/0311238 A1
(43) Pub. Date: Oct. 8, 2026

(54) Method and System for Providing Artificial Intelligence (AI)-based Proactive and Dynamic Subscription Plan Recommendation

(71) Applicant: T-Mobile Innovations LLC, Overland Park, KS (US)

(72) Inventors: Henry CYRIL, SE Bothell, WA (US); Rajesh SHRIVASTAVA, SE Bothell, WA (US); Shrustishree SUMANTH, SE Bothell, WA (US)

(21) Appl. No.: 19/173,786

(22) Filed: Apr. 8, 2025

(51) Int. Cl. G06Q 30/0601; H04W 4/24

(52) U.S. Cl. CPC G06Q 30/0631; H04W 4/24

(57) ABSTRACT

A method implemented in a telecommunication network to proactively, dynamically provision subscription plans for a specific subscriber based on individual subscriber data analysis and subscriber group data analysis, the method comprising training machine learning (ML) models using first user data, subscription plan data, user-subscription interaction data associated with respective ones of subscribers of the telecommunication network, wherein the first user data comprises historical communication usage data associated with respective ones of the subscribers; identifying second user data comprising past usage data and current usage data associated with communication usage of a specific subscriber through the telecommunication network; identifying current subscription plan data associated with the specific subscriber; applying the trained ML models to the second user data and the current subscription plan data of the specific subscriber to predict a recommended subscription plan for the specific subscriber; and initiating a notification to the specific subscriber of the recommended subscription plan.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A telecommunications network provider may have numerous service brands that offer different rate plans to their subscribers. The features or services offered by the rate plans may differ substantially between the different service brands. For example, prepaid plans may require customers to prepay and have a balance before using a service like making a call, whereas postpaid plans may allow customers to accumulate charges and bill the customers at the end of each month. Features such as fifth generation (5G) access, the number of gigabytes of online data, the number of calling minutes or unlimited calling, call forwarding, international roaming, and domestic roaming may vary among the different rate plans.

Telecommunications provisioning or network provisioning may refer to the process of preparing and equipping a telecommunications network to provide services to users based on their subscribed rate plans. This involves setting up and configuring the necessary hardware and software infrastructure, ensuring that all required resources are available and properly configured to deliver the intended telecommunications services, such as voice, text, and/or data.

### SUMMARY

In an embodiment, a method implemented in a telecommunication network to proactively and dynamically identify recommended subscription plans for a specific subscriber based on an individual subscriber data analysis and a subscriber group data analysis using artificial intelligence (AI), the method comprising training, by a first application stored in non-transitory memory of a computer system and executable by a processor of the computer system, one or more machine learning (ML) models using first user data, subscription plan data, user-subscription interaction data associated with respective ones of a plurality of subscribers of the telecommunication network, wherein the first user data comprises historical communication usage data associated with respective ones of the plurality of subscribers; identifying, by a second application stored in the non-transitory memory of the computer system and executable by the processor of the computer system, second user data comprising past usage data and current usage data associated with communication usage of the specific subscriber through the telecommunication network; identifying, by the second application, current subscription plan data associated with the specific subscriber; applying, by the second application, the trained one or more ML models to the second user data and the current subscription plan data of the specific subscriber to predict at least one recommended subscription plan for the specific subscriber; and initiating, by the second application, an action to notify the specific subscriber of the at least one recommended subscription plan.

In yet another embodiment, a method implemented in a telecommunication network, the method comprising identifying, by a first application stored in non-transitory memory of a computer system and executable by a processor of the computer system, from a customer detail record (CDR) database, past usage data and current usage data associated with communication usage of a specific subscriber through the telecommunication network respectively during a past period and a current period; identifying, by the first application, from at least one of a network provisioning process log or a network provisioning catalog, subscription plan data comprising features associated with a current subscription plan of the specific subscriber; analyzing, by the first application, the past usage data, the current usage data, and the subscription plan data of the specific subscriber, using one or more machine learning (ML) models, to predict a subscription recommendation opportunity for the specific subscriber and identify one or more recommended subscription plans for the specific subscriber based on the predicted subscription recommendation opportunity, wherein the one or more ML models are trained on communication usage data, subscription plan data, and user-subscription interaction data associated with a plurality of subscribers of the telecommunication network; initiating, by the first application, an action to notify the specific subscriber of the one or more recommended subscription plans; and adapting, by a second application stored in the non-transitory memory of the computer system and executable by the processor of the computer system, one or more parameters of the one or more ML models based on feedback associated with a response of the specific subscriber to the one or more recommended subscription plans.

In yet another embodiment, a method comprising identifying, by an application stored in non-transitory memory of a computer system and executable by a processor of the computer system, individual subscriber data comprising first communication usage data associated with communication activities of a specific subscriber through a telecommunication network and first subscription plan data associated with the specific subscriber; analyzing, by the application, the individual subscriber data associated with the specific subscriber against subscriber group data comprising second communication usage data, second subscription plan data, and user-subscription interaction data associated with a plurality of subscribers of the telecommunication network, using a first model, to predict a subscription recommendation opportunity; determining, by the application, at least one recommended subscription plans for the specific subscriber based on the predicted subscription recommendation opportunity using a second model; determining, by the application, based on one or more rules, whether the at least one recommended subscription plan is allowable for the specific customer; and initiating, by the application, based on the determination that the at least one recommended subscription plan is allowable for the specific customer, an action to provision the recommended at least one subscription plan to the specific subscriber.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, where like reference numerals represent like parts.

FIG. 1 is a block diagram of a network system according to an embodiment of the disclosure.

FIG. 2 is a block diagram of a network provisioning system according to an embodiment of the disclosure.

FIG. 3 is a block diagram of a telecommunication network according to an embodiment of the disclosure.

FIG. 4 illustrates an example tariff configuration and an example customer detail record (CDR) according to an embodiment of the disclosure.

FIG. 5 illustrates an example method for recommending a subscription plan to a specific subscriber using artificial intelligence (AI) according to an embodiment of the disclosure.

FIG. 6 illustrates an example method for training machine learning (ML) models to recommend a subscription plan to a specific subscriber according to an embodiment of the disclosure.

FIG. 7 is a flow chart of a method according to an embodiment of the disclosure.

FIG. 8 is a flow chart of another method according to an embodiment of the disclosure.

FIG. 9 is a flow chart of yet another method according to an embodiment of the disclosure.

FIG. 10A and FIG. 10B are block diagrams of a fifth generation (5G) network according to an embodiment of the disclosure.

FIG. 11 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As discussed above, a telecommunication service provider may provide various rate plans under various brands. The different rate plans may cater for different needs, for example, including unlimited data plans, prepaid options, postpaid options, domestic roaming plans, international roaming plans, business plans, and/or family plans. The different rate plans may have different service features and different pricing structures. The service features may be associated with, for example, but are not limited to, the amount of data usage and/or speed, the number of minutes for voice calls, international roaming, domestic roaming, and hotspot data usage and/or speed. The service provider may offer a certain base rate plan with the options to choose add-on plan(s). As an example, the service provider may offer a base rate plan including unlimited free domestic voice calls, unlimited data with slowdowns after 50 gigabytes (GB), and 5 GB hotspot data for $50 per month. Under the base rate plan, the service provider may offer pay-as-you-go international calls for $0.2 per minute. The service provider may also offer a stateside international add-on plan for $ 15 per month for unlimited international calls to 70 destinations. If a user subscribing to that base rate plan makes over 75 minutes of international calls per month to one or more of those 70 destinations, it may be more cost-effective for the user to add the stateside international add-on plan to their subscription rather than using the pay-as-you-go international call option. As another example, the service provider may offer a plan with 10 GB of hotspot data for $50 per month or a plan with unlimited hotspot data for $80 per month. If a user uses more than 20 GB of hotspot data per month, it may be more cost-effective for the user to select the plan with the unlimited hotspot data for $80 per month.

A service provider may generally provide numerous rate plans with different add-on plans. As such, it may be difficult for a user to choose the best base rate plan and the best add-on plan(s). Additionally, the user's needs may change over time. For instance, the user may have add-on plans that are no longer needed, but those add-on plans are automatically billed monthly. Additionally or alternatively, the user may have new needs or new communication patterns (e.g., international roaming or an increase in data usage for a certain period) that are not covered by the current subscription plan of the user, and thus may incur an additional cost. As such, users may often have bill shock when they receive their bills (with unexpected additional costs), causing dissatisfaction and leading to the users switching to other service providers. Furthermore, the service provider may offer new rate plans and/or new add-on plans from time to time and/or regional based offers or add-ons. However, it may be confusing and difficult for users to track and monitor the available rate plans and their usage regularly to select the best rate plan and/or add-on plan(s).

In other situations, a customer may call customer care to enquire about a better rate plan (e.g., with a lower cost or a higher data performance). A customer care agent may often take 10 to 20 minutes to gather customer information, such as the customer's current subscription, current needs, and projected future needs, from the customer and then additional time to find the most suitable or best rate plan and/or add-on plan(s) for the customer. This can be time-consuming and costly for customer care and may still result in the customer switching to another service provider.

The present disclosure provides a technical solution to the aforementioned technical problems in the technical field of subscription plan recommendation using an artificial intelligence (AI)-driven subscription recommendation system to proactively and dynamically recommend a subscription plan to a particular subscriber of a service provider. As used herein, a subscription plan may include a rate plan (e.g., for voice, text, and/or data) and/or one or more add-on plans (e.g., international add-on plans, high-speed data passes, hotspot data boost, inflight Internet, 4K video streaming, etc.). The proactive, dynamic subscription plan recommendation is based on two types of analyses, an individual subscriber data analysis and a subscriber group data analysis. The individual subscriber analysis includes analyzing past communication activities or usage (e.g., in past billing period(s)), current communication activities or usage (e.g., in a current billing period), and a current subscription plan of the particular subscriber. The subscriber group analysis includes analyzing subscription plans, communications activities or usage, and user-subscription interactions (e.g., calls to customer care about subscription plans, customer satisfaction reports or statistics, subscription activations, subscription deactivations, etc.) across a large number of subscribers (e.g., tens of thousands or millions) of the service provider. The recommendation is built upon a combination of these two analyses.

In a use case scenario, the analyses may provide an indication that subscribers having a similar current situation (e.g., a similar communication pattern) and a similar subscription plan as the particular subscriber have a churn rate of 5 percent (%), which is higher than the average churn rate of 1 % across all customer base of the service provider. The analyses may further provide an indication that subscribers having a similar current situation as the particular subscriber and a certain plan X have a churn rate of 1 %, and thus may recommend plan X to the particular subscriber. In another use case scenario, the analyses may indicate that subscribers having a similar current situation and a similar subscription plan as the particular subscriber have a low satisfaction (e.g., ratings of 1-2 stars) and that subscribers having a similar current situation as the specific subscriber and plan X has a high satisfaction (e.g., ratings of 4-5 stars). By proactively recommending plan X to the particular subscriber near real time (e.g., before the end of a billing cycle), it may be less likely for the particular subscriber to have a low satisfaction and/or switch to another service provider.

According to an embodiment of the present disclosure, the AI-driven subscription recommendation system may analyze past communication usage (e.g., in past billing period(s)), current communication usage (e.g., in a current billing period), and a current subscription plan of a specific subscriber against communication usage data, subscription plan data, and user-subscription interaction data across a large set of subscribers (e.g., tens of thousands or millions of subscribers) using one or more machine learning (ML) models to recommend subscription plans to the specific subscriber. The subscription plan data may include, for example, but is not limited to, subscription features such as data limits, call minutes, pricing, etc., subscribed by the subscribers. The user-subscription interaction data may include, for example, but is not limited to, customer satisfaction information (e.g., subscription plan ratings of 1 to 5 stars), subscriber churn rate information (e.g., churn rates related to various subscription plans and/or various subscribers), and/or subscription upgrades and/or downgrades.

In an embodiment, the AI-driven subscription recommendation system may include a subscription recommendation application (e.g., software) that recommends subscription plans to individual subscribers of a service provider. For instance, the subscription recommendation application may identify past usage data and current usage data associated with communication usage of a specific subscriber through a telecommunication network of the service provider. The past usage data and current usage data may be associated with a voice call service, a text messaging service, or a data service used by the specific subscriber. The past usage data may be associated with communication usage during past billing cycle(s) or period(s). The current usage data may be associated with communication usage during a current billing cycle or period (e.g., at a time before the end of current billing cycle). The past usage data and the current usage data may include information associated with each communication activity in each respective period. The information associated with each communication activity may include, for example, but is not limited to, a traffic type (e.g., voice, text, data) of the respective communication activity, an amount of usage (e.g., number of minutes for calls, number of bytes for text and/or data) associated with the respective communication activity, charge information (e.g., $0.2 per minute for voice calls to a certain country, free domestic voice calls, etc.) associated with the respective communication activity, a location type (e.g., domestic or international), and/or a country associated with each communication activity in a respective period.

In an embodiment, the past usage data and the current usage data may be identified from customer detail records (CDRs) that are generated by an online charging system (OCS) of the service provider. As will be discussed below, an OCS is a real-time metering service platform (e.g., including software applications) that authorizes, tracks, and calculates charges of communication usage of each subscriber through the telecommunication network in real time. Tracking the usages and calculating the charges in real time enable the OCS to provide the current usage data (before the end of the current billing cycle). As an example, the subscriber may be billed monthly by the service provider. The current usage data may refer to usage data accumulated within the current month up to the current time (e.g., 10 days into the billing cycle) before the end of the current billing cycle. As will be discussed more fully below, analyzing not only past or historical communication usage of the subscriber but also the current communication usage of the subscriber enables the subscription recommendation application to proactively provide a subscription recommendation (e.g., to change a rate plan and/or add an add-on plan) to the specific subscriber in a near real time manner rather than reactively waiting till the end of the billing period when the additional charge had already been added to the subscriber's bill.

Next, the subscription recommendation application may identify current subscription plan data of the specific subscriber. The current subscription plan data may include features (e.g., data limits, call minutes, pricing, etc.) of a current rate plan and/or add-on plan(s) of the specific subscriber. In an embodiment, the current subscription plan data of the specific subscriber may be identified based on a network provisioning process log, a network provisioning catalog (NPC), and a tariff or rate configuration. The network provisioning process log may be generated by a network provisioning engine (NPE) (e.g., software application(s)) of the service provider. As will be discussed more fully below, the NPE may receive a transaction event when a subscriber initiates a certain action (e.g., activation, deactivation, etc.) associated with a subscription. The NPC is a technical catalog that translates customer facing service specifications (CFSs) (e.g., voice, text, and/or data features of subscription plans or rate plans) to network facing specifications (NFSs) (e.g., network service attributes) and used by the NPE to configure network elements (NEs) in the network to provision the subscribed services to the subscriber. The NPE may log transaction events and corresponding timestamps (e.g., when the respective events were initiated) in the network provisioning process log. The tariff configuration may be generated by the OCS as part of the CDR generation. As such, the subscription recommendation application may obtain information about when the specific subscriber activated the current subscription plan from the network provisioning process log, obtain information about the features of the current subscription plan from the NPC, and obtain pricing or rate information (e.g., unlimited domestic voice calls and 5 GB of data for $50 a month, $0.2 per minute for calls to China, $0.15 per minute for voice calls to Japan, etc.) associated with the subscription plan from the tariff configuration.

Next, the subscription recommendation application may analyze the past usage data, the current usage data, and the subscription plan of the specific subscriber, using one or more machine learning (ML) models, to predict a subscription recommendation opportunity for the specific subscriber and recommend one or more subscription plans to the specific subscriber based on the predicted subscription recommendation opportunity. As will be discussed more fully below, the one or more ML models may be trained on the communication usage data (e.g., historical communication activity data), the subscription plan data, and the user-subscription interaction data associated with the large set of subscribers of the telecommunication network. The predicted subscription recommendation opportunity may refer to an opportunity where the specific subscriber may benefit from a change (e.g., an upgrade or a downgrade of a base rate plan, an add-on plan addition or removal, etc.) to the current subscription plan of the specific subscriber (e.g., due to a change in the communication pattern of the specific subscriber and/or new available rate plans and/or add-on plans).

The predicted subscription recommendation opportunity may be associated with, for example, but not limited to, voice calls, international calls (e.g., overage), domestic data, international roaming, domestic roaming, and hotspot data. As an example, the specific subscriber may be travelling internationally during the current billing period, and thus may benefit from a different international calling and/or roaming plan. For instance, the one or more ML models may recommend an add-on international plan based on the predicted subscription recommendation opportunity. Thus, in some instances, the predicted subscription recommendation opportunity may be based on a communication usage pattern of the specific subscriber. As another example, the current subscription plan of the specific subscriber may allow for a particular threshold number of service units (e.g., 10 GB high-speed data) within a 30-days billing period, but the current communication usage is likely to exceed the threshold. For instance, the specific subscriber may have already consumed 8 GB of high-speed data 10 days into the billing period. Thus, in some instances, the predicted subscription recommendation opportunity predicted may be based on a threshold number of service units allocated for the subscription plan of the specific subscriber and the number of service units that are already used by the specific subscriber in the current billing period.

In an embodiment, as part of the analyzing, the subscription recommendation application may process the past usage data, the current usage data, and the subscription plan of the specific subscriber using a first ML model (e.g., a prediction model) of the one or more ML models to predict the subscription recommendation opportunity of the specific subscriber. The subscription recommendation application may further process the subscription recommendation opportunity of the specific subscriber using a second ML model (e.g., a recommendation model) of the one or more ML models to generate the recommended one or more subscription plans. In some instances, the first ML model and the second ML model are two separate ML models. In other instances, the first ML model and the second ML model correspond to the same ML model. For example, in some instances, a single ML model may be trained to perform the subscription recommendation opportunity prediction and subscription recommendation. The one or more ML models may generally be of any suitable deep learning architectures. In some examples, the one or more ML models may be matrix factorization model(s), clustering model(s), and/or classification model(s). In another embodiment, as part of the analyzing, the subscription recommendation application may apply an automated script (e.g., software processing logics) to the predicted subscription recommendation opportunity to recommend the one or more subscription plans for the specific subscriber based on a set of rules instead of using a second ML model. As an example, a rule may specify that plan Y may be the next rate plan when there is an international calls overage indicated by the predicted subscription recommendation opportunity. As another example, an ML model may recommend a plan A as a first choice, followed by a plan B as a second choice for a particular customer. However, based on the rules, the particular customer may not be eligible for plan A. Thus, the plan B may be recommended to the particular customer instead of plan A. Generally, the rules (e.g., conditions and/or logics) may be defined to govern the recommendation results based on business rules and desired business results.

After determining the recommended one or more subscription plans, the subscription recommendation application may initiate an action to notify the specific subscriber of the recommended one or more subscription plans. In some examples, the recommendation may be fed to another system (e.g., a notification system) where the recommended one or more subscription plans may be sent to the specific subscriber (e.g., via an email, text, or call). The specific subscriber has the option to accept or reject the recommended one or more subscription plans. In an example, the one or more ML models may output a single recommended subscription plan for the specific subscriber and the specific subscriber may accept or reject that recommended subscription plan. In another example, the one or more ML models may output multiple recommended subscription plans for the specific subscriber along with corresponding ranking information (e.g., Rank 1: Plan A, Rank 2: Plan B, Rank 3: Plan C). In such an example, the specific subscriber may accept one of the recommended subscription plans or reject all recommended subscription plans. The acceptance and/or rejection from the specific subscriber may be provided as feedback for tuning or adapting the one or more ML models. For instance, the AI-driven subscription recommendation system may further include an ML model training application (e.g., software). The ML model training application may adapt one or more parameters of the one or more ML models based on the feedback. Generally, the ML model training application may retrain or retune the one or more ML models periodically at certain time intervals (e.g., daily, weekly, monthly, etc.) based on feedback associated with subscription plans recommended to various individual subscribers over the past time interval and may deploy the updated one or more ML models subsequently. In an example, the ML model training application may retune the one or more ML models daily and deploy the updated one or more ML models every few weeks (e.g., 2-3 weeks).

In an embodiment, instead of notifying the specific subscriber of the recommended subscription plan, the subscription recommendation application may automatically provision a subscription plan change for the specific subscriber (based on the recommended one or more subscription plans) with an option for the specific subscriber to reject the change. In some instances, the automatic provision may also include an automatic rollback of effective date of change in the OCS upon receiving a rejection from the specific subscriber. That is, the automatic provision may include switching the specific subscriber back to the previous subscription plan and adjusting the charges associated with the change.

Generally, the subscription recommendation application may sample the subscribers in any suitable way (e.g., regularly) to determine whether an individual subscriber may benefit from a subscription plan change. As an example, the sampling of the subscribers may be based on the plan segments (e.g., pre-paid plans, postpaid plans, etc.) associated with the subscriptions of the subscribers. Additionally or alternatively, the sampling of the subscribers may be based on the rate plans subscribed by the subscribers. In some situations, an individual subscriber may have recently changed to a new subscription plan. For example, the current billing period is the first billing period for the new subscription plan. As such, it may be undesirable to immediately recommend another subscription plan to that subscriber as a full view of the subscriber's communication needs and/or usage versus the benefits of the current subscription plan may not have been established yet. Accordingly, in an embodiment, the subscription recommendation application may check that a certain time period (e.g., more than a threshold number of days) has elapsed since the activation of the new subscription plan before proceeding to initiate the one or more ML models to recommend a subscription plan for the specific subscriber. As discussed above, the network provisioning process log may store various subscription transaction events and corresponding timing information. As such, the subscription recommendation application may search, in the network provisioning process log, for the activation event associated with the new subscription plan of the specific subscriber and the corresponding timing information. The subscription recommendation application may compare the time when the activation event is initiated to the current time to determine an elapsed period since activation and compare the elapsed period to a threshold (e.g., 30 days or more). If the elapsed period fails to satisfy (e.g., below) the threshold, the subscription recommendation application may refrain from performing the analysis to recommend a new subscription plan to the specific subscriber. If, however, the elapsed period satisfies (e.g., greater than or equals) the threshold, the subscription recommendation application may proceed with the subscription recommendation processing.

According to a further embodiment of the present disclosure, the one or more ML models may be trained using supervised learning. For instance, the ML model training application may train the one or more ML models using the communication usage data, the subscription plan data, and the user-subscription interaction data of each individual subscriber in the set of subscribers (e.g., a training dataset). The one or more ML models may process the communication usage data, the subscription plan data, and the user-subscription interaction data of each individual subscriber and output recommended subscription plans for the respective subscriber along with ranking information. The one or more ML models may output a list of recommended subscription plans and corresponding rankings for the respective individual subscriber. The ML model training application may evaluate the output of the one or more ML models against a reference subscription recommendation (e.g., a ground truth including a list of reference recommended subscription plans and corresponding rankings). The ML model training application may compute an error between the output of the one or more ML models and the reference subscription recommendation and may adapt one or more parameters of the one or more ML models based on the error. The ML model training application may repeat the training process until the error satisfies a threshold. The ML model training application may repeat the training process for each individual subscriber in the training dataset.

In an embodiment, as part of the training, the ML model training application may apply collaborative user-based filtering, collaborative item-based filtering, and/or content-based filtering to the subscriber group data (e.g., the communication usage data, the subscription plan data, and the user-subscription interaction data of the large set of subscribers) to generate reference subscriber recommendations (the ground truths). For collaborative user-based filtering, the reference subscription recommendations may be generated to recommend subscription plans that similar subscribers have selected. For collaborative item-based filtering, the reference subscription recommendations may be generated to recommend subscription plans to those that the subscriber has liked or selected in the past. For content-based filtering, the reference subscription recommendations may be generated by using subscription plan features (e.g., data limits, call minutes, pricing, etc.) to recommend subscription plans that match the subscriber's usage.

In some embodiments, the subscription recommendation may further leverage user profile data (e.g., demographics, payment history, preferences, etc.) of the subscribers. For instance, the one or more ML models may be trained further using user profile data of the large set of subscribers in addition to the historical communication usage data, subscription plan data, and user-subscription interaction data of the large set of subscribers. Further, the analysis of the specific subscriber's data may further include analyzing the specific subscriber's user profile data (e.g., demographics, payment history, and/or preferences of the specific subscriber) in addition to the past and current communication usage data and the current subscription plan data of the specific subscriber. That is, during deployment, the trained one or more ML model may further process the specific subscriber's user profile data to provide the subscription recommendation.

In a further embodiment, the subscription recommendation application may provide a user interface (UI) for interaction with customer care. For instance, a customer care agent may assist a subscriber to select a subscription plan. Instead of the customer care agent manually gathering information about the subscriber's usage needs or usage patterns, looking up available rate plans and add-on plans, and selecting a subscription plan from the available rate plans and add-on plans. The customer care agent may request for a subscription recommendation for the subscriber (e.g., by providing a phone number and/or an account number of the subscriber) via the UI, and the subscription recommendation application may recommend one or more subscription plans for the subscriber using mechanisms discussed above. The UI may display the list of recommended one or more subscription plans. The subscription recommendation application may take seconds to output the list of recommended subscription plans compared to the customer agent taking tens of minutes using the manual process, thereby increasing customer care efficiency and reducing cost.

Analyzing individual subscriber data (e.g., user profile, communication usage, and subscription plan data) of a specific subscriber against subscriber group data (e.g., user profile, communication usage, subscription, and user-subscription interaction data) across a customer base or subscriber base (e.g., a large number of subscribers) enables the subscription recommendation system to learn from subscriber journeys of the large number of subscribers to recommend subscription plans for the specific subscriber. Analyzing not only historical communication usage data but also the current communication usage data of the individual subscriber enables near real-time subscription recommendation (e.g., before the end of the subscriber's current billing cycle). Refraining from recommending subscription plans for a subscriber that has recently changed to a new subscription plan may avoid making a recommendation prematurely (e.g., before a full view of communication usage or pattern versus benefits of the new subscription plan is established). Periodically retuning the ML models after the ML models are deployed in production based on feedback from subscribers about respective recommended subscription plans can continually improve the accuracy of the ML models. Proactively and dynamically recommending subscription plans to individual subscribers can reduce customer churn rate, increase customer experience, and improve customer satisfaction. As an example, the proactive subscription recommendation may interrupt the process of a subscriber incurring a $100 bill (e.g., for pay-as-you-go international calls) by recommending an add-on plan for $10 per month (e.g., a state side international add-on plan). In some cases, proactively and dynamically recommending subscription plans to individual subscribers can boost revenue. For instance, high-performance (e.g., high-speed data) may be a concern for a certain subscriber. Thus, by recommending a premium subscription plan (with a higher cost) to the certain subscriber, it may improve the user experience and satisfaction of the subscriber and at the same time generate more revenue for the service provider.

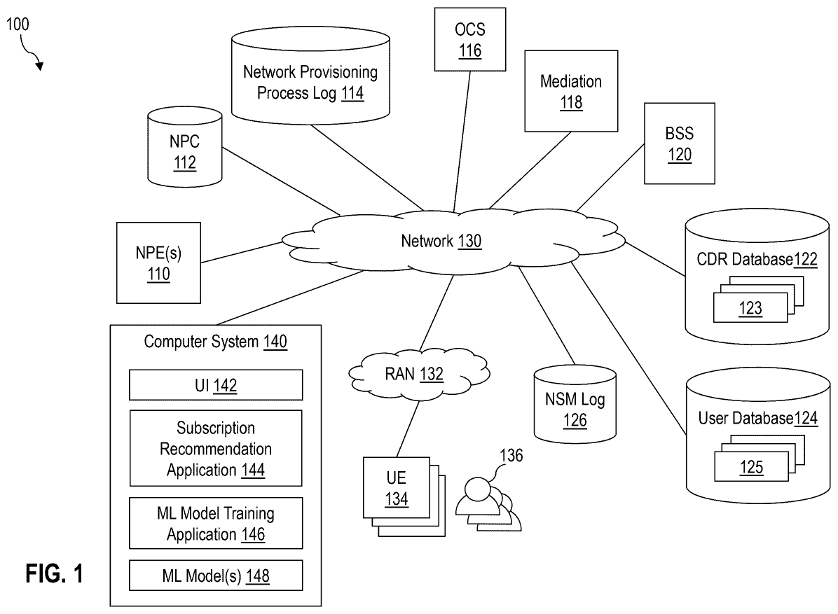

Turning now to FIG. 1, a network system 100 is described. The network system 100 may be a telecommunication service provider network or a mobile service provider network used for provisioning and providing communication services (e.g., voice services, short messaging services (SMSs), multimedia message services (MMSs), data services, hotspot services, Internet services, etc.) to subscribers 136 and recommending subscription plans to the subscribers 136. The network system 100 may generally service any suitable number of subscribers 136 (e.g., hundreds, tens of thousands, or millions). In an example, the network system 100 may be part of a wireless communication network (e.g., a long-term evolution (LTE) network, a fifth generation (5G) network, or a sixth generation (6G) network). As shown in FIG. 1, the network system 100 includes one or more NPEs 110, an NPC 112, a network provisioning process log 114, an OCS 116, a mediation 118, a billing support system (BSS) 120, a CDR database 122, a user database 124, a network service manager (NSM) log 126, a network 130, a radio access network (RAN) 132, and a computer system 140 (an AI-driven network provisioning subscription plan recommendation system). One or more of these components of the network system 100 may be implemented as software executing on a computer system or a plurality of computer systems.

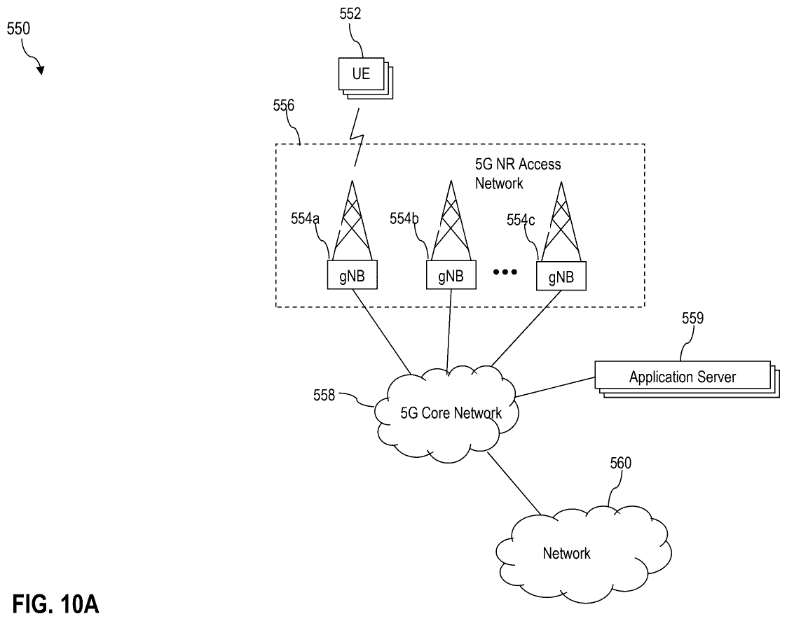

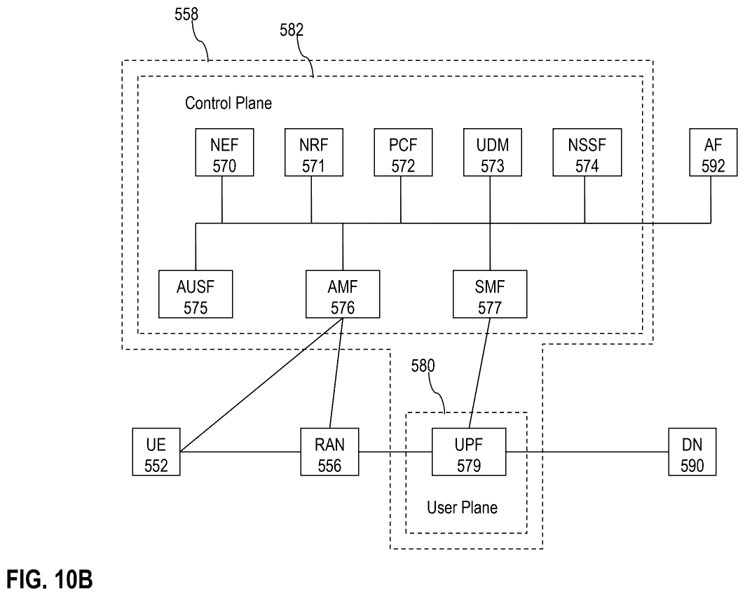

The RAN 132 may include a plurality of cell sites and backhaul equipment. In an embodiment, the RAN 132 includes tens of thousands or even hundreds of thousands of cell sites. The cell sites may include electronic equipment and radio equipment including antennas. The cell sites may be associated with towers or buildings on which the antennas may be mounted. The cell sites may include a cell site router that provides a backhaul link from the cell sites to the network 130. The cell sites may provide wireless links to user equipment (UE) 134 (e.g., mobile phones, smart phones, personal digital assistants, laptop computers, tablet computers, notebook computers, wearable computers, headset computers) according to an LTE, a 5G, or a 6G telecommunication protocol. An example of a 5G RAN is discussed below with reference to FIGS. 10A and 10B. The network 130 may include one or more public networks, one or more private networks, or a combination thereof. The RAN 132 may from some points of view be considered to be part of the network 130 but is illustrated separately in FIG. 1 to promote improved description of the network system 100. Further, in some examples, the network 130 may include a core network that connects the RAN 132 to other data networks in the network 130.

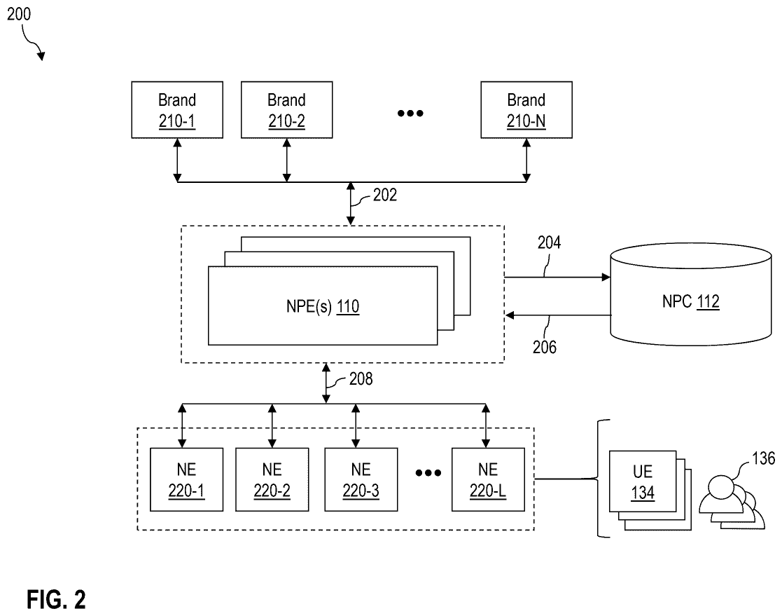

The NPEs 110 may be software application(s) executing on a computer system or servers(s). The NPEs 110 may be responsible for configuring NEs (e.g., the NEs 220 shown in FIG. 2) in the network 130 (or more specifically the core network) to provide services (e.g., voice, text, and/or data) to the UEs 134 of the subscribers 136 according to the respective subscription plans of the subscribers 136. In some examples, different NPEs 110 may be responsible for configuring different types or different brands of services and/or different technologies (e.g., 6G, 5G, LTE, etc.). In some examples, provisioning tasks may be distributed across multiple NPEs 110 to ensure high performance and avoid bottlenecks. In some examples, some NPEs 110 may be region specific to ensure a fast response time. In some examples, multiple NPEs 110 may be used to provide redundancy. In general, the NPEs 110 may be configured in any suitable way to handle provisioning tasks. The NPC 112 is a technical catalog that translates CFSs (e.g., voice, text, and/or data features of subscription plans or rate plans) to NFSs (e.g., network service attributes).

Generally, the configurations of the NEs are triggered by a transaction from a subscriber 136. For example, when a subscriber 136 activates or deactivates a certain subscription plan (e.g., for voice, text, and/or data services), an NPE 110 may receive a transaction event indicating the respective activation or the deactivation. The NPE 110 may request the NPC 112 to translate a CFS associated with the activation or deactivation of the subscription plan to an NFS. The NPE 110 may configure NEs according to the NFS (e.g., network service attributes) so that the NEs may provision the subscribed services to the subscriber 136. The NPE 110 may generate the network provisioning process log 114 as part of network provisioning. For instance, the NPE 110 may save all received transaction events and associated information in the network provisioning process log 114. Mechanisms for network provisioning and the different types of transaction will be discussed more fully below with reference to FIG. 2.

The user database 124 may store user profiles 125 of respective subscribers 136. The user profiles 125 may store various information, such as personal information, subscriber identification information, account and billing information, subscription plan information, preference information, etc., of the subscribers 136. Example personal information may include, but is not limited to, name, address, contact information, demographics. Example subscriber identification information may include, but is not limited to, international mobile subscriber identity (IMSI), mobile station international subscriber directory number (MSISDN), and billing account number. Example account and billing information may include, but is not limited to, billing account number, billing cycles and payment history, credit limit (e.g., for prepaid plans), charges (e.g., for postpaid plans or pay-as-you-go plans), account status (e.g., active, deactivated, suspended, etc.). Example subscription plan information may include, but is not limited to, active plan type (e.g., T-Mobile Magenta Plan, T-Mobile Go5G, etc.) and active add-on plans (e.g., international calls, international roaming, hotspot data, etc.). Example subscriber preference information may include indications of likes or dislikes of certain past subscription plans selected by the subscriber 136.

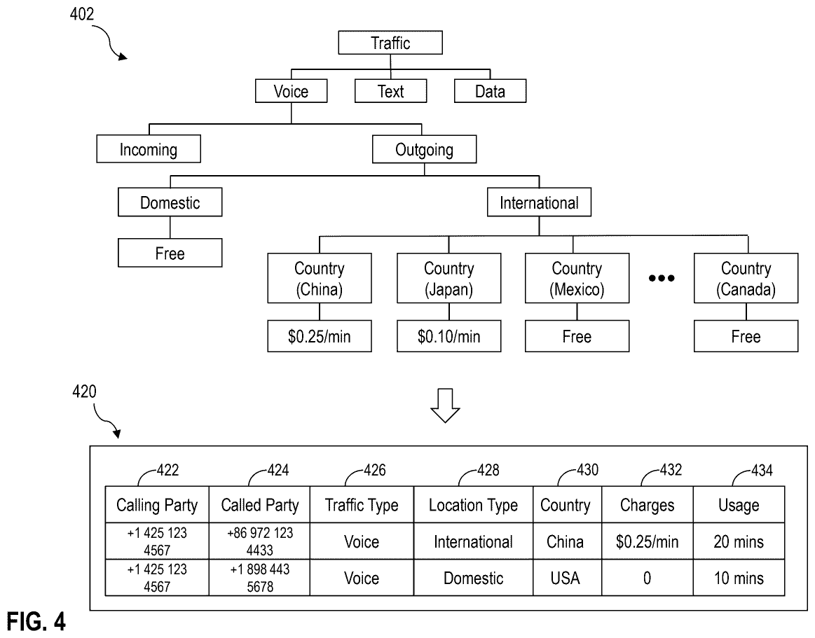

The OCS 116 is a real-time charging (or metering) service platform. The OCS 116 may authorize, track, and calculate charges of communication usages of a subscriber 136 through the RAN 132 and the corresponding core network. For instance, the OCS 116 may have access to subscription details of the subscribers 136 (e.g., from the user profiles 125 of the subscribers 136). The subscription details may include the type of subscription (e.g., prepaid, postpaid, etc.), included allowances or benefits (e.g., data limits, voice minutes, SMS limits, etc.), and add-on plans (e.g., international roaming, hotspot data, etc.). The OCS 116 may perform the authorization, tracking, and charge calculation for the communication usages of the subscribers 136 based on the respective subscription details of the subscribers 136. For instance, for authorization, the OCS 116 may check that a subscriber 136 meets the respective subscription plan criteria before the subscriber 136 accesses a service in the RAN 132 and the corresponding core network. As an example, when a subscriber 136 initiates an action (e.g., to make a call or stream a movie), the OCS 116 may check the subscriber 136's subscription status, usage, and service allowances (e.g., number of service units for call, number of service units for data, number of service units for SMS, etc.). If the conditions are met, the OCS 116 may authorize the request. For tracking, the OCS 116 may track and log voice, data, and messaging service usage of the subscriber 136 in real time. For instance, OCS 116 may continuously monitor and track communication activities of the subscriber 136 and calculate the amount of data or the number of call minutes consumed by the subscriber 136. For charge calculation, the OCS 116 may calculate the charges according to the amount of data or text or the number of call minutes used by the subscriber 136 and rates offered by the subscription plan of the subscriber 136. For instance, the OCS 116 may create a tariff configuration (e.g., the tariff configuration 402 shown in FIG. 4) and may update charges (e.g., for postpaid or pay-as-you-go plans) or deduct credits (e.g., for prepaid plans) based on the tariff configuration. In an example, the OCS 116 may generate a CDR 123 (e.g., the CDR 420 shown in FIG. 4) at the end of each communication session (e.g., a voice call, a text, or a data session) of each subscriber 136 including detailed information (e.g., the communication usage amount and corresponding charges, etc.) associated with the respective communication session. The OCS 116 may store the generated CDRs 123 in the CDR database 122. In some examples, the CDR database 122 may be linked (e.g., logically) to the user profiles 125 at the user database 124. Generally, the CDRs 123 and the user profiles 125 may be stored in any suitable databases and arranged in any suitable way.

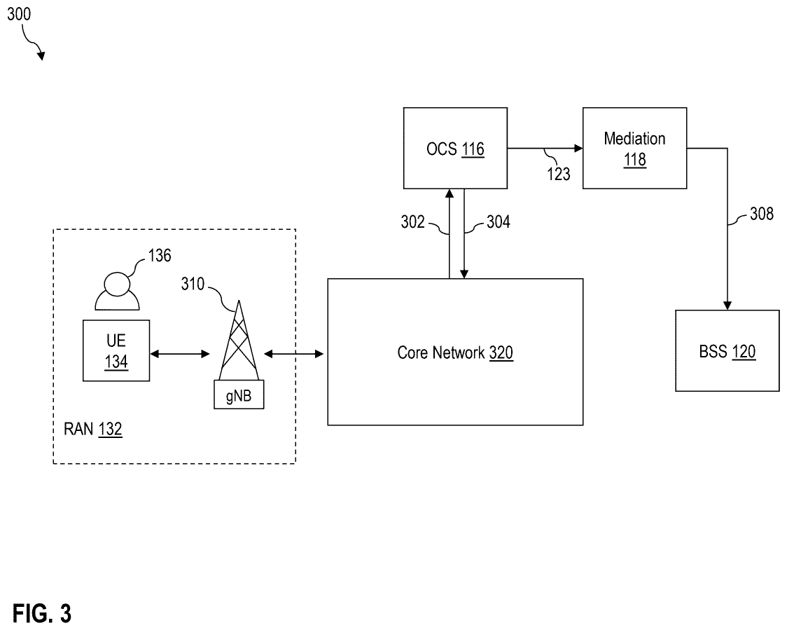

The mediation 118 operates as an intermediary between the OCS 116 and the BSS 120. The mediation 118 may collect and aggregate CDRs 123 received from the OCS 116. In some examples, the mediation 118 may convert the CDRs 123 into a data format suitable for processing by the BSS 120. The mediation 118 may route the aggregated and format-converted CDRs 123 to the BSS 120. The BSS 120 may generate billings for the subscribers 136 based on the CDR information received from the mediation 118. Mechanisms for metering and CDR creations will be discussed more fully below with reference to FIGS. 3-4.

The NSM log 126 is a log of interactions with customers or subscribers 136 in relation to their subscription plans. For instance, the NSM log 126 may include customer satisfaction indicators (e.g., a rating of 1 to 5 stars indicative of whether a subscriber 136 likes or dislikes a certain subscription plan or a certain add-on option). The NSM log 126 may also log activations, deactivations, upgrades, and downgrades of subscription plans made by the subscribers. As will be discussed more fully below, the NSM log 126 may store feedback from the subscribers 136 about subscription plans that are recommended to the respective subscribers 136 by the computer system 140 (the AI-driven network provisioning subscription plan recommendation system). In some examples, the NSM log 126 is generated as part of customer care.

As will be discussed more fully below, the data generated and collected during network provisioning and metering may be used to facilitate the subscription plan recommendation discussed herein. For instance, the CDRs 123 stored in the CDR database 122 may provide information associated with communication activities or usages and charges of the subscribers 136. The NPC 112 may provide information associated with features (e.g., data limit, call minutes, etc.) of the subscription plans subscribed by the subscribers 136. The network provisioning process log 114 may provide information associated with transaction activities (e.g., recent activations or deactivations, etc.) of the subscribers 136. The NSM log 126 may provide information associated with user-subscription interactions (e.g., customer satisfaction indicators, subscription activations, subscription de-activations, and/or subscription upgrades, subscription downgrades, feedback) of the subscribers 136. The tariff configurations generated by the OCS 116 may provide pricing information associated with the subscription plans subscribed by the subscribers 136.

The computer system 140 includes at least one processor and at least one non-transitory memory. The computer system 140 includes a subscription recommendation application 144 and an ML model training application 146 stored in the at least one non-transitory memory and executable by the at least one processor. The computer system 140 also includes one or more ML models 148 stored at the at least one non-transitory memory. According to an embodiment of the present disclosure, the subscription recommendation application 144 analyzes past communication usage (e.g., in past billing period(s)), current communication usage (e.g., in a current billing period), and current subscription plan data (e.g., features of a current rate plan and/or add-on plans) of an individual subscriber 136 against historical communication usage data, subscription plan data, and user-subscription interaction data across a large set of subscribers 136 (e.g., tens of thousands or millions of subscribers) to recommend one or more subscription plans for the individual subscriber 136 using the ML model(s) 148. The subscription plan data may include, for example, but is not limited to, subscription features such as data limits, call minutes, pricing, etc. subscribed by the users. The user-subscription interaction data may include, for example, but is not limited to, customer satisfaction information (e.g., 1 to 5 stars), subscriber churn rate information, and/or subscription upgrades and/or downgrades requested by the subscribers 136.

In some embodiments, the one or more ML models 148 may be further trained on user profile data (e.g., demographics, payment history, and/or preferences of the subscribers 136 obtained from the user profiles 125 of the user database 124) associated with the large set of subscribers 136. In such embodiments, the analysis of the specific subscriber 136's data may further include analyzing the specific subscriber's user profile data (e.g., demographics, payment history, and/or preferences of the specific subscriber obtained from a corresponding user profile 125 of the user database 124).

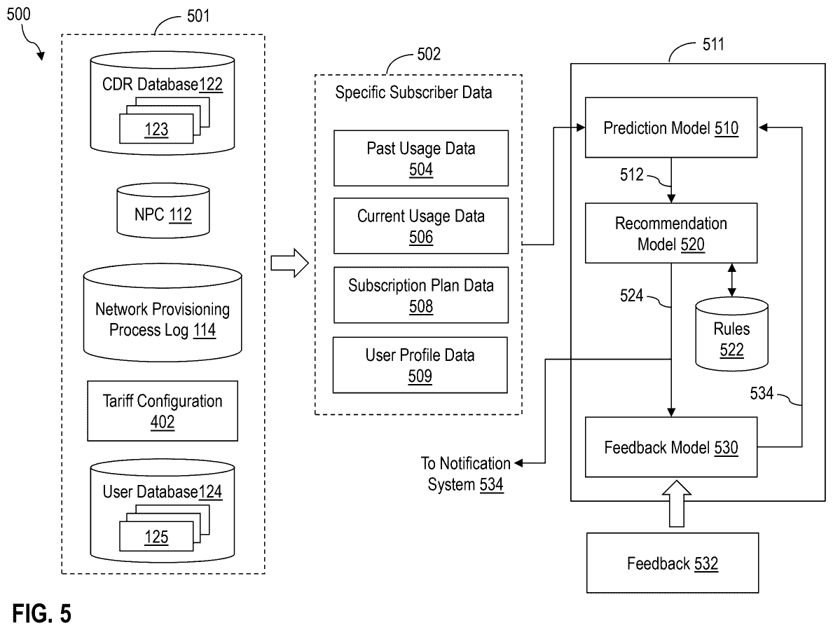

In an embodiment, the ML model training application 146 trains the ML model(s) 148 using the user data, the subscription plan data, and the user-subscription interaction data across the large set of subscribers 136. During an inference stage, the recommendation application 144 uses the trained ML model(s) 148 to recommend a subscription plan to a specific subscriber 136 based on past and current communication usage data and a current subscription plan of the specific subscriber 136. The specific subscriber 136 may be notified of the recommended subscription plan and may accept or reject the recommended subscription plan. During deployment, feedback associated with the recommended subscription plans may be collected from respective subscribers 136, and the ML model training application 146 may periodically retrain or retune the ML model(s) 148 based on the collected feedback. In an example, the subscription recommendation application 144 may obtain communication usage related data from the CDR database 122, subscription plan related data from the NPC 112, the network provisioning process log 114, and tariff configurations generated by the OCS 116, and user-subscription interaction and/or feedback related data from the NSM log 126. Mechanisms for recommending subscription plans to an individual subscriber using the ML model(s) 148 will be discussed more fully below with reference to FIGS. 5-9.

In an embodiment, the subscription recommendation application 144 may provide a UI 142 for interaction with customer care. For instance, a customer care agent may assist a subscriber 136 to select a subscription plan. Instead of the customer care agent manually gathering information about the subscriber 136's usage needs or usage patterns, looking up available rate plans and add-on plans, and selecting a subscription plan from the available rate plans and add-on plans, the customer care agent may request for a subscription recommendation for the subscriber 136 (e.g., by providing a phone number and/or an account number of the subscriber 136) via the UI 142. The subscription recommendation application 144 may recommend one or more subscription plans for the subscriber 136 using the method 500 discussed above. The UI 142 may display the list of recommended one or more subscription plans. The subscription recommendation application 144 may take seconds to output the list of recommended subscription plans compared to the customer agent taking 10-20 minutes using the manual process, thereby increasing customer care efficiency and reducing cost.

FIG. 1 is merely an example of components of a network system, and variations are contemplated to be within the scope of the present disclosure. In embodiments, the network system may include other components not illustrated in FIG. 1. In embodiments, the network system may not include every component illustrated in FIG. 1. In embodiments, the components and connections may be implemented with different connections than those illustrated in FIG. 1. For instance, the user profiles 125 in the user database 124, the CDRs 123 in the CDR database 122, the user-subscription interaction data in the NSM log 126 may be stored in any number of databases and arranged in any suitable way. Such and other embodiments are contemplated to be within the scope of the present disclosure.

Turning now to FIG. 2, a network provisioning system 200 is described. The network provisioning system 200 may be part of the network system 100 and may provide a more detailed view of components associated with network provisioning. The network provisioning system 200 includes a plurality of brands 210 (individually shown as 210-1, 210-2, . . . , 210-N, where N may be any suitable integer), NPEs 110, NPC 112, and a plurality of NEs 220 (individually shown as 220-1, 220-2, 220-3, . . . , 210-L, where L may be any suitable integer). The brands 210 may provide services (e.g., voice, text, and/or data) to subscribers 136 of UEs 134 using resources and infrastructures of the system 200. The different brands 210 may offer different subscription plans including, for example, but not limited to, prepaid plans, post-paid service brands, domestic roaming plans, international roaming plans, business plans, and/or family plans. In an example, the brands 210 may include T-Mobile postpaid, T-Mobile prepaid, wholesale, Magenta, Magenta postpaid, Sprint, etc. Further, each brand 210 may offer various service rate plans (e.g., a certain number of gigabytes of online data, unlimited calling, etc.).

The NPEs 110 may receive transaction events 202 associated with the brands 210 (e.g., via application programming interface (API) calls). The transaction events 202 may be of various transaction types, for example, including, but not limited to, a service activation, a service deactivation, a service suspension, a service restoration, a billing cycle change, a service feature change, an identity access management, a subscriber identity module (SIM) change, and a phone number change. A transaction event 202 is triggered when a subscriber 136 initiates an action related to a certain subscription plan offered by a certain brand 210 (e.g., the brand 210-1). The transaction event 202 may include an indication of the type of transaction and associated information (e.g., the brand 210-1). Upon receiving the transaction event 202, the NPE 110 may transmit, to the NPC 112, a CFS 204 corresponding to the brand 210-1 associated with the transaction event 202. The NPC 112 may translate the CFS 204 to corresponding NFS 206 and transmit the NFS 206 to the NPE 110. In an example, a CFS 204 may include features (e.g., VMSs, SMSs, data or Internet services, etc.) of a corresponding subscription plan. An NFS 206 may include network service attributes for configuring NEs 220. In an example, the network service attributes may specify particular NEs 220, parameters, and corresponding parameter values. Upon receiving the NFS 206, the NPE 110 may configure NEs 220 according to the NFS 206 by transmitting provisioning instructions 208 to the respective NEs 220.

The NEs 220 are network nodes including hardware and software components configured to provide services to the UEs 134 based on respective provisioning instructions 208 received from the NPE 110. The NEs 220 may be part of a core network (e.g., part of the network 130 of FIG. 1). Examples of NEs 220 may include, for example, but are not limited to, over-the-air (OTA) nodes, provisioning gateway (PGW), home location register (HLR), home subscriber server (HSS), application publisher, SMS server, VMS server, web services gateway (WSG), charging system, femtocell provisioning nodes, identity access management (IAM) system, etc. In the context of 5G or 6G, the NEs 220 may be network nodes that implement network functions as discussed below with reference to FIGS. 10A-10B.

Turning now to FIG. 3, a telecommunication network 300 is described. The telecommunication network 300 is part of the network system 100 and may provide a more detailed view of metering operations in the network system 100. As shown in FIG. 3, a RAN 132 including a UE 134 and a next Generation Node B (gNB) 310 is connected to a core network 320. The core network 320 may be part of the network 130. The gNB 310 is an access node in fifth-generation (5G) technology. The gNB 310 may communicate with the UE 134 to establish a wireless communication link with the UE 134. The gNB 310 may connect the UE 134 to other networks (e.g., the Internet) via the core network 320. A subscriber 136 of the UE 134 may subscribe to a subscription plan for services (e.g., voice, text, and/or data) in the telecommunication network 300.

As discussed above, the OCS 116 may authorize, track, and charge services used by a subscriber 136 of a UE 134. To that end, the OCS 116 may track various information associated with each service included by the subscription plan of the subscriber 136. For instance, the OCS 116 may have information associated with a domestic data limit, a voice limit, a text or SMS, an international calling limit, an international roaming limit, etc. of the subscription plan. In an example, the OCS 116 may maintain a bucket (e.g., a data structure) for each type of services (e.g., domestic data, voice call, text, etc.) and a corresponding limit or threshold (e.g., a variable in the data structure). The OCS 116 may also have information regarding the behavior of the bucket after a corresponding limit is reached. As such, the OCS 116 may further apply a respective threshold to each bucket and may apply a respective behavior upon the bucket reaching the respective threshold.

As an example, the subscription plan of the subscriber 136 may provide unlimited high-speed data with a slowdown after 5 GB. Thus, the OCS 116 may assign a bucket with a threshold of 5 GB for tracking data usage of the subscriber 136's UE 134. For example, the bucket may be a data structure including a threshold variable set to 5 GB and a usage variable initialized to 0 at the beginning of a billing cycle. When the core network 320 detects that the UE 134 initiates an access to a data service, the core network 320 may transmit a metering request 302 to the OCS 116. The OCS 116 may check whether the data bucket (e.g., the usage variable) has reached the 5 GB threshold. If the data bucket hasn't reached the 5 GB threshold, the OCS 116 may respond to the metering request 302 by transmitting, to the core network 320, a metering response 304 indicating that the core network 320 and/or the RAN 132 may serve the UE 134 with high-speed data transfer (e.g., a high data bandwidth allocation). The core network 320 may also inform the OCS 116 of the amount of data used by the UE 134 so that the OCS 116 may update the data bucket (e.g., the usage variable) accordingly. If, however, the data bucket has reached the 5GB threshold, the OCS 116 may respond to the metering request 302 by transmitting, to the core network 320, a metering response 304 indicating that that the core network 320 and/or the RAN 132 may serve the UE 134 with a lower speed data transfer (e.g., a reduced data bandwidth allocation).

The OCS 116 may generate a tariff configuration (e.g., the tariff configuration 402 shown in FIG. 4) and may generate a CDR 123 for each communication activity or usage of the UE 134. The OCS 116 may transmit each CDR 123 to the mediation 118. The mediation 118 may aggregate the CDRs 123 and transmit the aggregated CDRs 308 to the BSS 120 (e.g., for billing the subscriber 136). In some instances, the aggregated CDRs 308 may be formatted or arranged in a format suitable for the BSS 120.

Turning now to FIG. 4, an example tariff configuration 402 and an example CDR 420 are described. The tariff configuration 402 may be generated by the OCS 116 for a particular subscriber 136. The tariff configuration 402 has a tree structure and may be referred to as a rating tree. As shown in the tariff configuration 402, the traffic of subscriber 136 is categorized into voice, text, and data. The voice traffic is further categorized into incoming and outgoing. The outgoing voice traffic is further categorized into domestic and international voice traffic. In the illustrated example of FIG. 4, the tariff configuration 402 indicates that the domestic outgoing voice traffic is free and further indicates the country and the corresponding fee or cost for international outgoing voice traffic. As shown, international calls to China have a fee of $0.25 per minute, international calls to Japan have a fee of $0.1 per minute, international calls to Mexico and Canada are free, and so on. For ease of illustration, FIG. 4 only shows rate information for voice calls in the tariff configuration 402. However, the tariff configuration 402 may generally include rate information for each traffic type. For instance, the tariff configuration 402 may include a leaf node under text indicating free and a leaf node under data indicating a 5 GB data limit for $10 per month.

As further shown in FIG. 4, the CDR 420 may be generated based on the tariff configuration 402. The CDR 420 is an aggregated CDR. Each row in the CDR 420 may correspond to a particular communication session (e.g., voice, text, or data) of a particular subscriber 136. For instance, each row in the CDR 420 may correspond to a CDR 123 generated by the OCS 116 and stored in the CDR database 122. In some instances, the CDR 420 may correspond to the aggregated CDR 308 generated by the mediation 118. As shown, the CDR 420 may include a calling party field 422, a called party field 424, a traffic type field 426, a location type field 428, a country field 430, a charge field 432, and a usage field 434. The calling party field 422 and the called party field 424 may only be applicable for voice traffic, where the calling party field 422 may indicate the phone number (e.g., the MSISDN) of the calling party and the called party field 424 may indicate the phone number of the called party. The traffic type field 426 may indicate whether the traffic is voice, text, or data. The location type field 428 may indicate whether the traffic is international or domestic. The country field 430 may indicate the country in which the traffic is initiated. The charges field 432 may indicate the charges for the corresponding traffic type and/or country of initiation. The usage field 434 may indicate the amount of usage (e.g., number of minutes for voice calls, number of bytes for data, etc.).

FIG. 4 is merely an example of a tariff configuration 402 and a CDR 420, and variations are contemplated to be within the scope of the present disclosure. In embodiments, the tariff configuration 402 may include other categories and/or the CDR 420 may include other fields not illustrated in FIG. 4. In embodiments, the tariff configuration 402 may not include every category and/or the CDR 420 may not include every field illustrated in FIG. 4. Generally, a CDR 420 may include any suitable fields that may facilitate billing. Such and other embodiments are contemplated to be within the scope of the present disclosure.

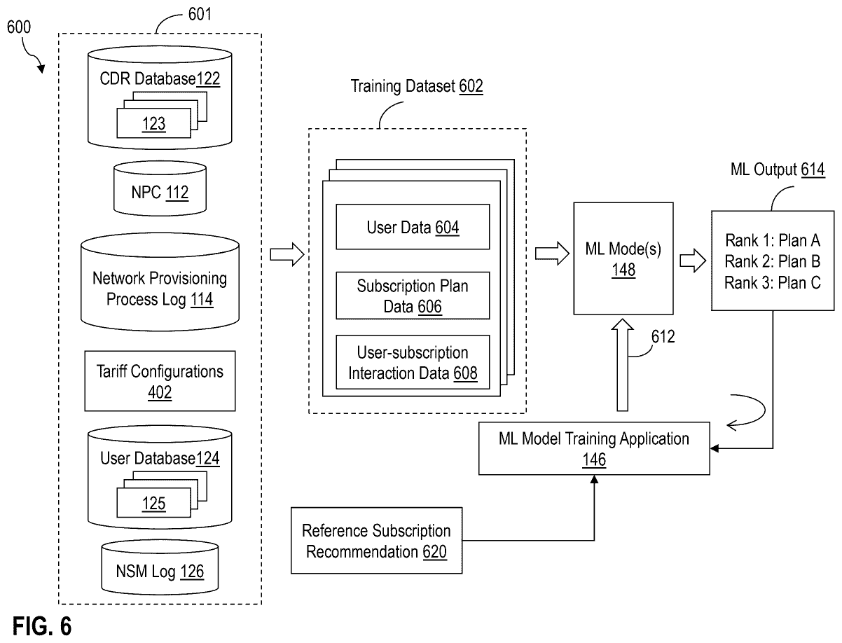

As discussed above, the ML model training application 146 trains the ML models 148 using user data, subscription plan data, and user-subscription interaction data across a large set of subscribers 136. During an inference stage, the subscription recommendation application 144 uses the trained ML models 148 to recommend a subscription plan to a specific subscriber 136 based on past and current communication usage data and a current subscription plan of the specific subscriber 136. The specific subscriber 136 may be notified of the recommended subscription plan and may accept or reject the recommended subscription plan. During deployment, feedback associated with recommended subscription plans may be collected from respective subscribers 136, and the ML model training application 146 may periodically retrain or retune the ML models 148 based on the collected feedback. Mechanisms for performing subscription plan recommendation using the trained ML models 148 and retuning of the ML models 148 during deployment are discussed below with reference to FIG. 5. Mechanisms for training the ML models 148 are discussed below with reference to FIG. 6.

Turning now to FIG. 5, an example method 500 for recommending a subscription plan to a specific subscriber 136 using AI is described. The method 500 may be implemented by the subscription recommendation application 144 and the ML model training application 146. For instance, the subscription recommendation application 144 may identify individual subscriber data 502 specific to the specific subscriber 136 from data 501 generated and collected from the network system 100. The data 502 may include past usage data 504, current usage data 506, subscription plan data 508, and user profile data 509 of the specific subscriber 136. The past usage data 504 and the current usage data 506 may provide detail information (e.g., similar to the information in the CDR 420 shown in FIG. 4) associated with communication usage of the specific subscriber 136 through the network system 100 (or more specifically through the telecommunication network 300) respectively during a past billing or subscription period (e.g., a past month) and a current billing or subscription period (e.g., a current month). The user profile data 509 may include demographics, payment history, and preferences of the specific subscriber 136. In some instances, the user profile data 509 may be optional. The data 501 collected from the network system 100 may include CDRs 123 that are stored at the CDR database 122, the NPC 112, the network provisioning process log 114, and the tariff configuration 402.

The subscription recommendation application 144 may identify the past usage data 504 and the current usage data 506 of the specific subscriber 136 from the CDR database 122, for example, based on a phone number or MSISDN of the specific subscriber 136. Each of the past usage data 504 and the current usage data 506 may include information associated with each communication activity (e.g., each voice, text, or data communication session) of the specific subscriber 136 in the respective billing period. For instance, the information for a particular communication activity may indicate a traffic type (e.g., the traffic type field 426) associated with the particular communication activity, a communication usage amount (e.g., the usage field 434) associated with the particular communication activity, a charge (e.g., the charges field 432) associated with the particular communication activity, a location type (e.g., the location type field 428) associated with the particular communication activity, and/or a country (e.g., the country field 430) associated with the particular communication activity. In some instances, at least some of the past usage data 504 and/or current usage data 506 of the specific subscriber 136 may be determined based on charge data obtained from international roaming platforms that are partners of the service provider. The subscription recommendation application 144 may identify the user profile data 509 by looking up a user profile 125 from the user database 124 corresponding to the MSISDN or account number of the specific subscriber 136.

The subscription recommendation application 144 may identify the subscription plan data 508 of the specific subscriber 136 based on the NPC 112, the network provisioning process log 114, and the tariff configuration 402. The subscription plan data 508 may include, for example, but is not limited to, subscription features such as data limits, call minutes, pricing, etc. of a current subscription plan of the specific subscriber 136. The subscription recommendation application 144 may obtain, from the network provisioning process log 114, information about when the specific subscriber 136 activated the current subscription plan. The subscription recommendation application 144 may obtain, from the NPC 112, information about the features of the current subscription plan. The subscription recommendation application 144 may obtain, from the tariff configuration 402, pricing information (e.g., unlimited domestic voice calls and 5 GB of data for $50 a month, $0.2 per minute for calls to China, $0.15 per minute for voice calls to Japan, etc.) associated with the subscription plan.

Next, the subscription recommendation application 144 may perform subscription plan recommendation processing 511. For instance, the subscription recommendation application 144 may provide the past usage data 504, the current usage data 506, the subscription plan data 508, and the user profile data 509 of the specific subscriber 136 to the prediction model 510 (e.g., an ML model 148). The prediction model 510 may process the past usage data 504, the current usage data 506, the subscription plan data 508, and the user profile data 509 of the specific subscriber 136 to predict a subscription recommendation opportunity 512 for the specific subscriber 136. The predicted subscription recommendation opportunity 512 is an indication that the specific subscriber 136 may benefit from a certain subscription change (e.g., an upgrade or a downgrade of a base rate plan, an add-on plan addition or removal, etc.) to the current subscription plan of the specific subscriber (e.g., due to a change in the communication pattern of the specific subscriber and/or new available rate plans and/or add-on plans). Examples of the predicted subscription recommendation opportunity 512 may include, but are not limited to, voice calls, international calls (e.g., overage), domestic data, international roaming, domestic roaming, and hotspot data. As an example, the subscription recommendation opportunity 512 may indicate that the specific subscriber 136 is making more international calls in the current billing cycle and may benefit from an international add-on plan. As an example, the subscription recommendation opportunity 512 may indicate that the specific subscriber 136 has consumed almost all high-speed hotspot data allocated for the current subscription plan and may benefit from a premium hotspot data plan. As another example, a customer or subscriber may utilize roaming services in Canada and/or Mexico Customer is roaming and may be paying a premium cost for those services, and thus the subscription recommendation opportunity 512 may indicate that the subscriber may benefit from a rate plan that offers Canada/Mexico roaming as free add-on as part of that rate plan.

Next, the subscription recommendation application 144 may provide the predicted subscription recommendation opportunity 512 to the recommendation model 520. The recommendation model 520 may recommend one or more subscription plans 524 to the specific subscriber 136 based on the predicted subscription recommendation opportunity 512 and rules 522. The rules 522 may include a list of rate plans and/or add-ons and corresponding pricings that are offered by the service provider at the current time and a mapping to corresponding subscription recommendation opportunities. In a first example, a rule 522 may specify that if a customer previously subscribed to a plan A and recently moved to a plan B, the plan A may not be recommended again for that customer. In a second example, a rule 522 may specify that a certain plan (e.g., a plan C) may only be recommended to employee accounts. In a third example, a rule 522 may specify that if a customer is already on plan D, plan E will NOT be recommended. In a fourth example, a rule 522 may specify that no recommendation is to be provided to customers related to a certain organization (e.g., Government) because those customers are not allowed to change their plans per certain legal reasons. In a fifth example, a rule 522 may specify that no recommendation is to be provided to mobile virtual network operator (MVNO) customers. In a sixth example, a rule 522 may specify that a recommendation may only be provided to customers send once per quarter.

In an example, the recommendation model 520 may be an ML model 148, and, in some instances, rules 522 may be applied to the output of the ML model 148 to prevent passing an adverse recommendation generated by the ML model 148 to the notification system 534. In another example, the recommendation model 520 may be an automated script (e.g., processing logics) that selects one or more subscription plans 524 from the list of available subscription plans based on the predicted subscription recommendation opportunity 512 and the rules 522. The recommendation model 520 may recommend the selected one or more subscription plans 524 to the specific subscriber 136. In yet another embodiment, the prediction model 510 and the recommendation model 520 may be combined into a single ML model 148. That is, a single ML model 148 may be trained to perform subscription recommendation opportunity prediction and subscription plan recommendation.

In some instances, the recommendation model 520 may output a single subscription plan 524 recommended for the specific subscriber 136. In other instances, the recommendation model 520 may output multiple subscription plans 524 recommended for the specific subscriber 136 and may further provide ranking information for those subscription plans. For instance, the recommendation model 520 may output the subscription plans 524 in an order of the ranking (e.g., from the highest ranked subscription plan 524 to the lowest ranked subscription plan 524, or vice versa). Alternatively, the recommendation model 520 may output the subscription plans 524 and respective rankings (e.g., high, medium, low, or any suitable ranking indicators).

After determining the one or more recommended subscription plans 524 for the specific subscriber 136, the subscription recommendation application 144 may initiate an action to notify the specific subscriber 136 of the recommended subscription plans 524. For instance, the subscription recommendation application 524 may transmit an indication of the highest ranked subscription plan 524 to a notification system 534. The notification system 534 may notify the specific subscriber 136 of the highest ranked recommended subscription plan 524 (e.g., via an email, a text message, or a voice call). Alternatively, the subscription recommendation application 524 may transmit an indication of all the recommended subscription plans 524 to the notification system 534, and the notification system 534 may notify the specific subscriber 136 of all the recommended subscription plans 524. In some instances, the notification system 534 may be part of marketing (e.g., an upsell campaign) that is responsible for promoting subscription plans to subscribers 136 of the service provider.

Upon the specific subscriber 136 receiving the notification indicating a single recommended subscription plan 524, the specific subscriber 136 may accept or reject the recommended subscription plan 524. The specific subscriber 136 may also rate the recommended subscription plan 524 (e.g., from 1 to 5 with 1 being the lowest rating, or vice versa). Alternatively, upon the specific subscriber 136 receiving the notification indicating multiple recommended subscription plans 524, the specific subscriber 136 may select one of the recommended subscription plans 524 or reject all of the recommended subscription plans 524, and/or rate each of the recommended subscription plan 524 (e.g., from 1 to 5 with 1 being the lowest rating, or vice versa). The specific subscriber 136's response (e.g., acceptance or rejection and/or the rating) may be provided to the feedback model 530 as feedback 532. In some instances, the subscription recommendation application 144 may also provide the one or more recommended subscription plans 524 to the feedback model 530. The feedback model 530 may associate the received feedback 532 to a corresponding recommended subscription plan 524.

The subscription recommendation application 144 may repeat the process of predicting a subscription plan recommendation opportunity 512 and recommending subscription plan(s) 524 to each individual subscriber 136 of the service provider. After providing each subscription recommendation, the subscription recommendation application 144 may monitor for feedback 532 from the respective subscriber 136. The feedback model 530 may collect all the feedback 532. The ML model training application 146 may periodically retrain or retune the prediction model 510 and/or the recommendation model 520 by initiating the feedback model 530 to feed the received feedback 532 to the prediction model 510 and/or the recommendation model 520. Mechanisms for training or retraining the prediction model 510 and/or the recommendation model 520 will be discussed more fully below with reference to FIG. 6.

Generally, the subscription recommendation application 144 may sample the subscribers 136 in any suitable way (e.g., regularly) to determine whether an individual subscriber 136 may benefit from a subscription plan change. In some situations, an individual subscriber 136 may have recently changed to a new subscription plan. For example, the current billing period is the first billing period for the new subscription plan. As such, it may be undesirable to immediately recommend another subscription plan to that subscriber 136 as a full view of the subscriber 136's communication needs versus the benefits of the current subscription plan may not be established yet. Accordingly, in an embodiment, the subscription recommendation application 144 may check that a certain time period (e.g., more than a threshold number of days) has elapsed since the activation of the new subscription plan before proceeding to initiate the prediction model 510 and the recommendation model 520 to recommend a subscription plan for the specific subscriber. As discussed above, the network provisioning process log 114 may store various subscription transaction events 202 and corresponding timing information. As such, the subscription recommendation application 144 may search, in the network provisioning process log 114, for an activation event (e.g., a transaction event 202) associated with the new subscription plan of the specific subscriber 136 and the corresponding timing information. In an example, the subscription recommendation application 144 may compare the time when the activation event is initiated to the current time to determine an elapsed period since activation and compare the elapsed period to the threshold. If the elapsed period fails to (e.g., below) satisfy the threshold, the subscription recommendation application 144 may refrain from performing the analysis to recommend a new subscription plan to the specific subscriber 136. If, however, the elapsed period satisfies (e.g., greater than or equals) the threshold, the subscription recommendation application 144 may proceed with the subscription recommendation processing (by the prediction model 510 and the recommendation model 520).

Turning now to FIG. 6, an example method 600 for training ML models 148 to recommend a subscription plan to a specific subscriber is described. The method 600 may be implemented by the ML model training application 146. The ML model training application 146 may train the ML models 148 (e.g., the prediction model 510 and the recommendation model 520) using a training dataset 602. The training data set 602 (e.g., subscriber group data) may include user data 604, subscription plan data 606, and user-subscription interaction data 608 across a large set of subscribers 136 of the network system 100. The user data 604 may include, for example, but is not limited to, demographics, historical communication usage data, payment history, and/or preferences of the subscribers 136. In some instances, the historical communication usage data may include similar data fields as the past usage data 504 and/or the current usage 506 of the specific subscriber 136 discussed above with reference to FIG. 5. The subscription plan data 606 may include, for example, but is not limited to, subscription features such as data limits, call minutes, pricing, etc. subscribed by the subscribers 136 and corresponding ratings from the subscribers 136. The user-subscription interaction data 608 may include, for example, but is not limited to, customer satisfaction information (e.g., 1 to 5 stars), subscriber churn rate information, and/or subscription upgrades and/or downgrades requested by the subscribers 136. As an example, the customer satisfaction information may indicate that subscribers 136 with a certain communication pattern and on a certain subscription plan have a satisfaction rating of 5 stars. As an example, the customer churn rate statistical information may indicate that subscribers 136 with a certain communication pattern and on a certain subscription plan have a churn rate of 1%.

The ML model training application 146 may identify the user data 604, the subscription plan data 606, and the user-subscription interaction data 608 of the respective subscribers 136 from data 601 collected from the network system 100. The ML model training application 146 may identify the user data 604 from the CDR database 122 and the user database 124. For instance, the ML model training application 146 may identify the communication usage data of the subscribers 136 from CDRs 123 of the CDR database 122 and the other user profile information (e.g., demographics, payment history, and/or preferences) from the user profiles 125 of the user database 124. In some instances, at least some of the communication usage data of the subscribers 136 may be based on charge data from international roaming platforms that are partners of the service provider. The ML model training application 146 may identify the subscription plan data 606 from the NPC 112, the network provisioning log 114, and the tariff configurations 402 using similar mechanisms as discussed above with reference to FIG. 5. The ML model training application 146 may identify the user-subscription interaction data 608 from the NSM log 126. In some instances, the ML model training application 146 may identify the subscriber churn rate information (of the user-subscription interaction data 608) from the network provisioning process log 114 as the NPE 110 may capture transaction events 202 associated with deactivations of subscription plans.

The one or more ML models 148 may process the user data 604, the subscription plan data 606, and the user-subscription interaction data 608 of each individual subscriber 136 in the training data set 602 to provide an output 614 including recommended subscription plans for the respective subscriber along with ranking information. In the illustrated example of FIG. 6, the output 614 may indicate plans A, B, and C with plan A having the highest rank and plan C having the lowest rank. The ML model training application 146 may evaluate the output 614 of the one or more ML models 148 against a reference subscription recommendation 620 (e.g., a ground truth). To that end, the ML model training application 146 may compute an error between the output 614 of the one or more ML models 148 and the reference subscription recommendation 620 (e.g., based on a loss function or error function). The ML model training application 146 may adapt one or more parameters of the one or more ML models 148 based on the error (as shown by the arrow 612). The ML model training application 146 may repeat the training process until the error satisfies a threshold. As an example, the reference subscription recommendation 620 may indicate that plan B has the highest rank, and not plan A as output by the one or more ML models 148. The adapting of the parameters of the one or more ML models 148 may continue until the one or more ML models 148 output plan B as the highest rank-plan (e.g., Rank 1: plan B, Rank 2: plan A, Rank 3: plan C). As another example, the reference subscription recommendation 620 may indicate that plan D has the highest rank. The adapting of the parameters of the one or more ML models 148 may continue until the one or more ML models 148 output plan D as the highest rank-plan (e.g., Rank 1: plan D, Rank 2: plan B, Rank 3: plan C). The ML model training application 146 may repeat the training process for the user data 604, the subscription plan data 606, and the user-subscription interaction data 608 associated with each individual subscriber 136 in the training dataset 602.

The one or more ML models 148 may generally have any suitable deep learning or neural network architectures. In some examples, the one or more ML models 148 may be based on matrix factorization, clustering, and/or classification algorithms. In an example, an ML model 148 may include a plurality of layers, for example, an input layer, followed by one or more hidden layers and an output layer. Each layer may include a set of weights and/or biases that can transform inputs received from a previous layer and the resulting outputs can be passed to the next layer. The weights and/or biases in each layer can be trained and adapted, for example, to generate recommended subscription plans for an individual subscriber 136. The training of the ML model 148 may be based on a backpropagation process. The backpropagation process may perform a backward pass through the layers in the ML model 148 while adjusting the weights and/or biases at each layer.

In an embodiment, the ML model training application 146 may ingest real-time data events (e.g., the subscription related transaction events 202 captured by the NPE 110 in the network provisioning process log 114, the CDRs 123 generated by the OCS 116, and the interaction data captured in the NSM log 126). The ML model training application 146 may filter and aggregate those events to train and/or retrain the one or more ML models 148 (e.g., as discussed in the method 600). The filtering may be based on collaborative filtering (e.g., including user-based filtering and/or item-based filtering) and/or content-based filtering. The subscription recommendation application 144 may use the trained one or more ML models 148 to perform proactive or near real-time subscription recommendation for individual subscribers 136 (e.g., as discussed in the method 500). The subscription recommendation application 144 may provide the recommended subscription plans to the notification system 534, and the notification system 534 may notify the individual subscribers 136 of the respective recommended subscription plans (e.g., before the end of the billing cycles of the respective subscribers 136). The ML model training application 146 may monitor for feedback associated with the recommended subscription plans from respective subscribers 136. The ML model training application 146 may retrain or retune the one or more ML models 148 based on the feedback (e.g., as discussed in the methods 500 and 600). In some instances, the subscription recommendation application 144 may interact with a customer care agent serving a particular subscriber 136 via the UI 142 to recommend subscription plans for the particular subscriber 136. In some instances, the subscription recommendation application 144 may display recommended subscription plans for individual subscribers 136 on a dashboard of an operational support system (OSS) of the service provider, and operators of the OSS or customer care agents may reach out to those individual subscribers 136 (via emails, calls, and/or texts) to notify them of the respective proposed recommended subscription plans. Proactively recommending subscription plans to individual subscribers 136 in a near real-time manner (before the end of their respective billing cycles) may allow the respective subscribers to choose an alternative option (e.g., add-on plans) before incurring further cost to the current bill, thereby increasing customer satisfaction, improving user experience, and reducing churn rate.

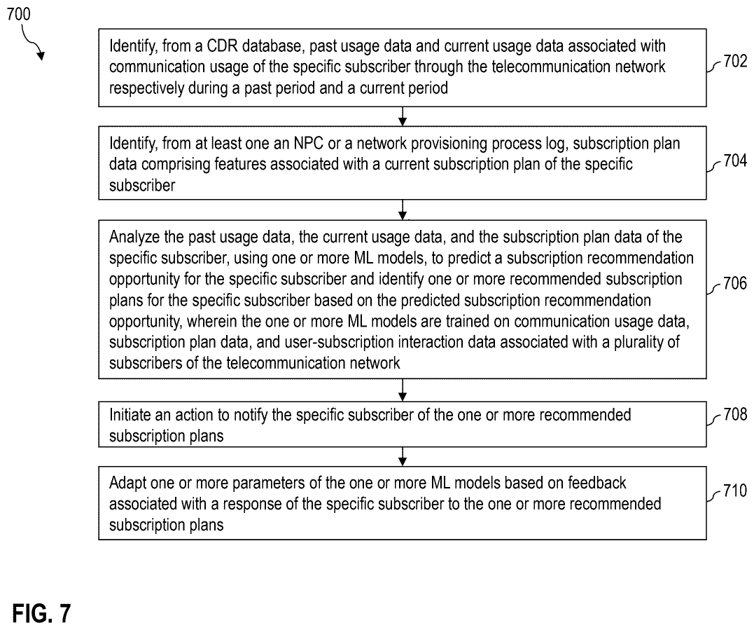

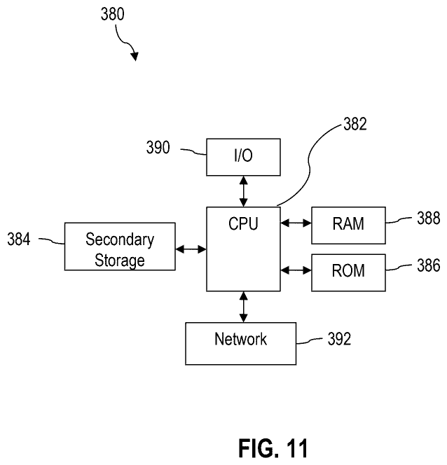

Turning now to FIG. 7, a method 700 is described. In an embodiment, the method 700 is a method of proactively and dynamically identifying recommended subscription plans 524 for a specific subscriber 136 based on an individual subscriber data analysis and a subscriber group data analysis using one or more ML models 148. The method 700 may include similar mechanisms as discussed above with reference to FIGS. 1-6. In embodiments, the method 700 may be implemented using a computer system with components as shown in FIG. 11. As illustrated, FIG. 7 includes a number of enumerated operations, but embodiments of the operations in FIG. 7 may include additional operations before, after, and in between the enumerated operations. In some embodiments, one or more of the enumerated operations may be omitted or performed in a different order.

At block 702, a first application (e.g., the subscription recommendation application 144) identifies, from a CDR database 122, past usage data 504 and current usage data 506 associated with communication usage of the specific subscriber 136 through a telecommunication network 300 respectively during a past period (e.g., past billing or subscription period) and a current period (e.g., a current billing or subscription period). In an embodiment, the past usage data 504 and the current usage data 506 of the specific subscriber 136 includes, for each respective period, at least one of a traffic type (e.g., the traffic type field 426) associated with a communication activity in the respective period, an amount of usage (e.g., the usage field 434) associated with the respective communication activity, charge information (e.g., the charge field 432) associated with the respective communication activity, a location type (e.g., the location type field 428) associated with the respective communication activity, or a country (e.g., the country field 430) associated with the respective communication activity.

At block 704, the first application identifies, from at least one of a network provisioning process log 114 or an NPC 112, subscription plan data 508 including information associated with a current subscription plan of the specific subscriber 136. In an embodiment, as part of identifying the subscription plan data 508 of the specific subscriber 136, the first application identifies, from the network provisioning process log 114, a subscription activation event associated with the current subscription plan of the specific subscriber 136. The first application further identifies, from the NPC 112, communication service unit allocation information (e.g., 10 GB data, unlimited domestic calls, 5 GB high-speed hotspot data, etc.) associated with the current subscription plan of the specific subscriber 136. The first application further identifies, from a tariff configuration 402, pricing information (e.g., $10 per month for a base rate plan, $0.2 per minute for international call to China, etc.) associated with the current subscription plan of the specific subscriber 136.

At block 706, the first application analyzes the past usage data 504, the current usage data 506, and the subscription plan data 508 of the specific subscriber, using one or more ML models 148, to predict a subscription recommendation opportunity 512 for the specific subscriber 136 and identify one or more recommended subscription plans 524 for the specific subscriber 136 based on the predicted subscription recommendation opportunity 512. The one or more ML models 148 are trained on communication usage data (e.g., part of the user data 604), subscription plan data 606, and user-subscription interaction data 608 associated with a plurality of subscribers 136 of the telecommunication network 300. In an embodiment, the analyzing the past usage data 504, the current usage data 506, and the subscription plan data 508 is based on a time period elapsed since an activation of the current subscription plan of the specific subscriber satisfying a threshold (e.g., more than 10, 20, 30 or more days). In an embodiment, the predicted subscription recommendation opportunity 512 is associated with at least one of voice calls, international calls, domestic data, international roaming, domestic roaming, or hotspot data. In an embodiment, the predicted subscription recommendation opportunity 512 is associated with at least one of a communication usage pattern of the specific subscriber 136 or a particular threshold number of allocated service units associated with the current subscription plan. Generally, the predicted subscription recommendation opportunity 512 may be based on a usage of the specific subscriber 136 exceeding the number of service units allocated for the current subscription plan or a new communication need (e.g., a predicted communication pattern) of the subscriber 136.

In an embodiment, as part of the analyzing, the first application processes the past usage data 504, the current usage data 506, and the subscription plan data 508 of the specific subscriber 136, using a first ML model 148 of the one or more ML models 148, to predict the subscription recommendation opportunity 512. The first application further processes the subscription recommendation opportunity 512, using a second ML model 148 of the one or more ML models 148, to generate the one or more recommended subscription plans 524. In some embodiments, the first ML model 148 and the second ML model 148 may correspond to different ML model 148. For instance, the first ML model 148 may correspond to the prediction model 510 and the second ML model 148 may correspond to the recommendation model 520. In some embodiments, the first ML model 148 and the second ML model 148 may correspond to the same ML model 148. That is, a single ML model 148 is trained to perform the subscription recommendation opportunity prediction and the subscription recommendation. In an embodiment, the one or more ML models 148 output two or more recommended subscription plans 524 for the specific subscriber 136 and further output an indication of a ranking for each of the two or more recommended subscription plans 524.

At block 708, the first application initiates an action to notify the specific subscriber 136 of the one or more recommended subscription plans 524 (e.g., via a notification system 534). At block 710, a second application (e.g., the ML model training application 146) adapts one or more parameters of the one or more ML models 148 based on feedback 532 associated with a response of the specific subscriber 136 to the one or more recommended subscription plans 524. In an embodiment, the second application further receives the response of the specific subscriber 136 indicating an acceptance or a rejection of an individual one of the recommended one or more subscription plans 524.

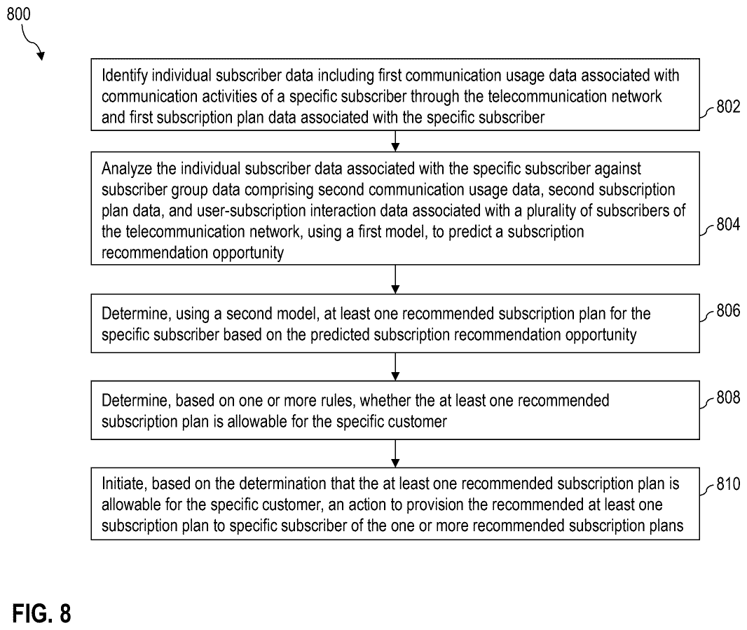

Turning now to FIG. 8, a method 800 is described. In an embodiment, the method 800 is a method of providing subscription plan recommendation. The method 800 may include similar mechanisms as discussed above with reference to FIGS. 1-7. In embodiments, the method 800 may be implemented using a computer system with components as shown in FIG. 11. As illustrated, FIG. 8 includes a number of enumerated operations, but embodiments of the operations in FIG. 8 may include additional operations before, after, and in between the enumerated operations. In some embodiments, one or more of the enumerated operations may be omitted or performed in a different order.

At block 802, an application (e.g., the subscription recommendation application 144) identifies individual subscriber data 502 including first communication usage data (e.g., past usage data 504 and current usage data 506) associated with communication activities (e.g., voice, text, and/or data) of a specific subscriber 136 through a telecommunication network 300 and first subscription plan data 508 associated with the specific subscriber 136. At block 804, the application analyzes the individual subscriber data 502 associated with the specific subscriber 136 against subscriber group data (e.g., the training dataset 602) including second communication usage data, second subscription plan data 606, and user-subscription interaction data 608 associated with a plurality of subscribers 136 of the telecommunication network 300, using a first model (e.g., the prediction model 510), to predict a subscription recommendation opportunity 512. At block 806, the application determines, using a second model (e.g., the recommendation model 520), at least one recommended subscription plan 524 for the specific subscriber 136 based on the predicted subscription recommendation opportunity 512.

At block 808, the application determines, based on one or more rules 522, whether the at least one recommended subscription plan 134 is allowable for the specific customer 136. The one more rules 522 based on at least one of a current subscription plan associated with the specific customer 136, a previous subscription plan associated with the specific customer 136, an organization associated with the specific customer 136, or a frequency of recommendation. For instance, in a first example, a rule 522 may specify that if a customer previously subscribed to a plan A and recently moved to a plan B, the plan A may not be recommended again for that customer. In a second example, a rule 522 may specify that a certain plan (e.g., a plan C) may only be recommended to employee accounts. In a third example, a rule 522 may specify that if a customer is already on plan D, plan E will NOT be recommended. In a fourth example, a rule 522 may specify that no recommendation is to be provided to customers related to a certain organization (e.g., Government) because those customers are not allowed to change their plans per certain legal reasons. In a fifth example, a rule 522 may specify that no recommendation is to be provided to mobile virtual network operator (MVNO) customers. In a sixth example, a rule 522 may specify that a subscription plan recommendation may only be provided to customers send once per quarter.

At block 810, the application initiates, based on the determination that the at least one recommended subscription plan 524 is allowable for the specific customer 136, an action to provision the recommended at least one subscription plan 524 to the specific subscriber 136 (e.g., via a notification system 534). In an embodiment, a second application (e.g., the ML model training application 146) adapts one or more parameters of the at least one of the first model or the second model based on feedback 532 associated with the recommended at least one subscription plan 524.

In an embodiment, the individual subscriber data 502 further includes user profile data 509 associated with the specific subscriber 136, and the subscriber group data further includes user profile data associated with respective ones of the plurality of subscribers 136. In such an embodiment, the analyzing at block 804 further includes analyzing the user profile data 509 associated with the specific subscriber 136 against the user profile data associated with respective ones of the plurality of subscribers 136.

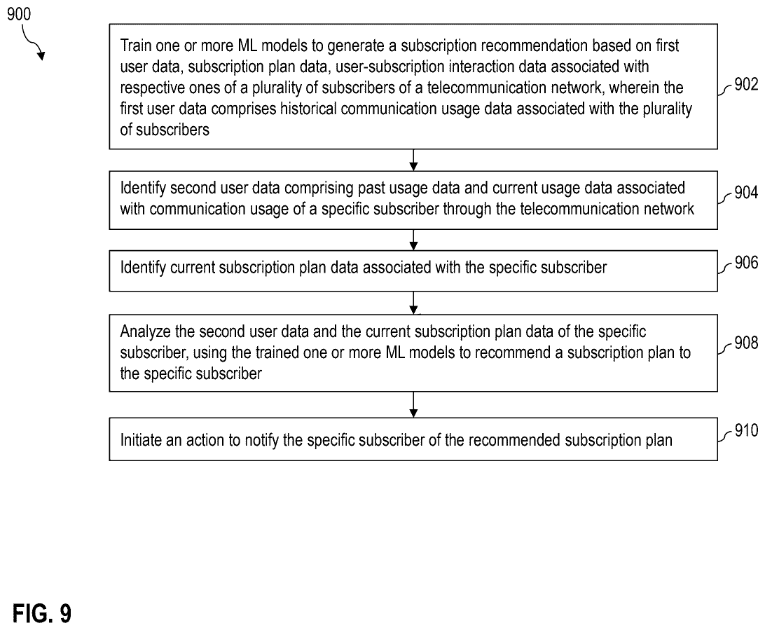

Turning now to FIG. 9, a method 900 is described. In an embodiment, the method 900 is a method of training ML models 148 to perform subscription recommendation and deploying the trained ML models 148 in production. The method 900 may include similar mechanisms as discussed above with reference to FIGS. 1-8. In embodiments, the method 900 may be implemented using a computer system with components as shown in FIG. 11. As illustrated, FIG. 9 includes a number of enumerated operations, but embodiments of the operations in FIG. 9 may include additional operations before, after, and in between the enumerated operations. In some embodiments, one or more of the enumerated operations may be omitted or performed in a different order.

At block 902, a first application (e.g., the ML model training application 146) trains one or more ML models 148 using first user data 604, subscription plan data 606, user-subscription interaction data 608 associated with respective ones of a plurality of subscribers 136 of a telecommunication network 300. The first user data 604 includes historical communication usage data associated with respective ones of the plurality of subscribers 136. In an embodiment, as part of training the one or more ML models 148, the first application processes the first user data 604, the subscription plan data 606, and the user-subscription interaction data 608 associated with each subscriber 136 of the plurality of subscribers 136 using a first ML model 148 of the one or more ML models 148 to output a predicted subscription recommendation opportunity 512. Further, the first application processes the predicted subscription recommendation opportunity using a second ML model 148 of the one or more ML models 148 to predict at least one recommended subscription plan 524 for the respective subscriber 136. Further, the first application updates one or more parameters of at least one of the first ML model 148 or the second ML model 148 based on an evaluation of the at least one recommended subscription plan 524 for the respective subscriber 136 against a reference subscription recommendation 620.

In another embodiment, as part of training the one or more ML models 148, the first application processes the first user data 604, the subscription plan data 606, and the user-subscription interaction data 608 associated with each subscriber 136 of the plurality of subscribers 136 using a first ML model 148 of the one or more ML models 148 to predict at least one recommended subscription plan 524 for the respective subscriber 136. Further, the first application updates one or more parameters of the first ML model 148 based on an evaluation of the recommended at least one subscription plan 524 for the respective subscriber 136 against a reference subscription recommendation 620. In an embodiment, as part of training the one or more ML models 148, the first application further applies at least one of collaborative filtering or content-based filtering to the first user data 604, the subscription plan data 606, the user-subscription interaction data 608 associated with the respective ones of the plurality of subscribers 136 (e.g., to generate reference subscription recommendations 620 for the evaluation of the ML model(s) 148).

At block 904, a second application (e.g., the subscription recommendation application 144) identifies second user data including past usage data 504 and current usage data 506 associated with communication usage of a specific subscriber 136 through the telecommunication network 300. At block 906, the second application identifies current subscription plan data 508 (e.g., including features of a current subscription plan) associated with the specific subscriber 136. At block 908, the second application applies the trained one or more ML models 148 to the second user data and the current subscription plan data 508 of the specific subscriber 136 to predict at least one recommended subscription plan 524 for the specific subscriber 136. At block 910, the second application initiates an action to notify the specific subscriber 136 of the at least one recommended subscription plan 524.

In an embodiment, the first user data 604 further includes first user profile data associated with at least one of demographics, payment histories, or subscription preferences of respective ones of the plurality of subscribers 136. That is, the one or more ML models 148 may be trained further using the first user profile data (of the respective ones of the plurality of subscribers). In such an embodiment, the second user data further includes second user profile data 509 associated with at least one of a demographic, a payment history, or a subscription preference of the specific subscriber 136. That is, the applying at block 908 further applies the trained one or more ML models 148 to process the second user profile data 509 (of the specific subscriber 136).

Turning now to FIG. 10A, an exemplary communication system 550 is described. Typically, the communication system 550 includes a number of access nodes 554 that are configured to provide coverage in which UEs 552 such as cell phones, tablet computers, machine-type-communication devices, tracking devices, embedded wireless modules, and/or other wirelessly equipped communication devices (whether or not user operated), can operate. The access nodes 554 may be said to establish an access network 556. The access network 556 may be referred to as a RAN in some contexts. In a 5G technology generation an access node 554 may be referred to as a next Generation Node B (gNB). In 4G technology (e.g., LTE technology) an access node 554 may be referred to as an evolved Node B (eNB). In 3G technology (e.g., code division multiple access (CDMA) and global system for mobile communication (GSM)) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G” such as LTE, which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general Internet service providers for laptops and desktop computers, competing with existing ISPs such as cable Internet, and also will make possible new applications in Internet of things (IoT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in RF spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 10B, further details of the core network 558 are described. In an embodiment, the core network 558 is a 5G core network. 5G core network technology is based on a service based architecture paradigm. Rather than constructing the 5G core network as a series of special purpose communication nodes (e.g., an HSS node, a MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 5A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be executed on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

FIG. 11 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, RAM 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, USB interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as CDMA, global system for mobile communications (GSM), LTE, WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented in a telecommunication network to proactively and dynamically provision one or more subscription plans for a specific subscriber based on an individual subscriber data analysis and a subscriber group data analysis using artificial intelligence (AI), the method comprising:
training, by a first application stored in non-transitory memory of a computer system and executable by a processor of the computer system, one or more machine learning (ML) models using first user data, subscription plan data, user-subscription interaction data associated with respective ones of a plurality of subscribers of the telecommunication network, wherein the first user data comprises historical communication usage data associated with respective ones of the plurality of subscribers;
identifying, by a second application stored in the non-transitory memory of the computer system and executable by the processor of the computer system, second user data comprising past usage data and current usage data associated with communication usage of the specific subscriber through the telecommunication network;
identifying, by the second application, current subscription plan data associated with the specific subscriber;
applying, by the second application, the trained one or more ML models to the second user data and the current subscription plan data of the specific subscriber to predict at least one recommended subscription plan for the specific subscriber; and
initiating, by the second application, an action to notify the specific subscriber of the at least one recommended subscription plan.

2. The method of claim 1, wherein the training the one or more ML models comprises:
processing the first user data, the subscription plan data, and the user-subscription interaction data associated with each subscriber of the plurality of subscribers using a first ML model of the one or more ML models to output a predicted subscription recommendation opportunity;
processing the predicted subscription recommendation opportunity using a second ML model of the one or more ML models to predict at least one recommended subscription plan for the respective subscriber; and
updating one or more parameters of at least one of the first ML model or the second ML model based on an evaluation of the at least one recommended subscription plan for the respective subscriber against a reference subscription plan recommendation.

3. The method of claim 1, wherein the training the one or more ML models comprises:
processing the first user data, the subscription plan data, and the user-subscription interaction data associated with each subscriber of the plurality of subscribers using a first ML model of the one or more ML models to predict at least one recommended subscription plan for the respective subscriber; and
updating one or more parameters of the first ML model based on an evaluation of the recommended at least one subscription plan for the respective subscriber against a reference subscription plan recommendation.

4. The method of claim 1, wherein the training the one or more ML models comprises:
applying at least one of collaborative filtering or content-based filtering to the first user data, the subscription plan data, the user-subscription interaction data associated with the respective ones of the plurality of subscribers.

5. The method of claim 1, wherein:
the first user data further comprises first user profile data associated with at least one of demographics, payment histories, or subscription preferences of respective ones of the plurality of subscribers, and
the second user data further comprises second user profile data associated with at least one of a demographic, a payment history, or a subscription preference of the specific subscriber.

6. The method of claim 1, wherein the one or more ML models are based on at least one of a matrix factorization, a clustering algorithm, or a classification model.

7. A method implemented in a telecommunication network, the method comprising:
identifying, by a first application stored in non-transitory memory of a computer system and executable by a processor of the computer system, from a customer detail record (CDR) database, past usage data and current usage data associated with communication usage of a specific subscriber through the telecommunication network respectively during a past period and a current period;
identifying, by the first application, from at least one of a network provisioning process log or a network provisioning catalog, subscription plan data comprising features associated with a current subscription plan of the specific subscriber;
analyzing, by the first application, the past usage data, the current usage data, and the subscription plan data of the specific subscriber, using one or more machine learning (ML) models, to predict a subscription recommendation opportunity for the specific subscriber and identify one or more recommended subscription plans for the specific subscriber based on the predicted subscription recommendation opportunity, wherein the one or more ML models are trained on communication usage data, subscription plan data, and user-subscription interaction data associated with a plurality of subscribers of the telecommunication network;
initiating, by the first application, an action to notify the specific subscriber of the one or more recommended subscription plans; and
adapting, by a second application stored in the non-transitory memory of the computer system and executable by the processor of the computer system, one or more parameters of the one or more ML models based on feedback associated with a response of the specific subscriber to the one or more recommended subscription plans.

8. The method of claim 7, wherein the past usage data and the current usage data of the specific subscriber comprises, for each respective period, at least one of:
a traffic type associated with a communication activity in the respective period,
an amount of usage associated with the respective communication activity,
charge information associated with the respective communication activity,
a location type associated with the respective communication activity, or
a country associated with the respective communication activity.

9. The method of claim 7, wherein the identifying the subscription plan data of the specific subscriber comprises:
identifying, by the first application, from the network provisioning process log, a subscription activation event associated with the current subscription plan of the specific subscriber;
identifying, by the first application, from the network provisioning catalog, communication service unit allocation features associated with the current subscription plan of the specific subscriber; and
obtaining, by the first application, from an online charging system, rate features associated with the current subscription plan of the specific subscriber.

10. The method of claim 7, wherein the analyzing the past usage data, the current usage data, and the subscription plan data is based on a time period elapsed since an activation of the current subscription plan satisfying a threshold.

11. The method of claim 7, wherein the predicted subscription recommendation opportunity is associated with at least one of:
voice calls,
international calls,
domestic data,
international roaming,
domestic roaming, or
hotspot data.

12. The method of claim 7, wherein the predicted subscription recommendation opportunity is associated with at least one of:
a communication usage pattern of the specific subscriber, or
a particular threshold number of allocated service units associated with the current subscription plan.

13. The method of claim 7, wherein the analyzing the past usage data, the current usage data, and the subscription plan data of the specific subscriber comprises:
processing, using a first ML model of the one or more ML models, the past usage data, the current usage data, and the subscription plan data of the specific subscriber to predict the subscription recommendation opportunity; and
processing, using a second ML model of the one or more ML models, the subscription recommendation opportunity to output the one or more recommended subscription plans.

14. The method of claim 7, wherein the one or more ML models output two or more recommended subscription plans for the specific subscriber and further output an indication of a ranking for each of the two or more recommended subscription plans.

15. The method of claim 7, further comprising:
receiving, by the second application, the response of the specific subscriber indicating an acceptance or a rejection of an individual one of the recommended one or more subscription plans.

16. The method of claim 7, wherein the user-subscription interaction data associated with the plurality of subscribers used for training the one or more ML models comprises at least one of:
customer satisfaction information,
subscriber churn rate information,
subscription plan upgrades, or
subscription plan downgrades.

17. A method comprising:
identifying, by an application stored in non-transitory memory of a computer system and executable by a processor of the computer system, individual subscriber data comprising first communication usage data associated with communication activities of a specific subscriber through a telecommunication network and first subscription plan data associated with the specific subscriber;
analyzing, by the application, the individual subscriber data associated with the specific subscriber against subscriber group data comprising second communication usage data, second subscription plan data, and user-subscription interaction data associated with a plurality of subscribers of the telecommunication network, using a first model, to predict a subscription recommendation opportunity;
determining, by the application, using a second model, at least one recommended subscription plan for the specific subscriber based on the predicted subscription recommendation opportunity;
determining, by the application, based on one or more rules, whether the at least one recommended subscription plan is allowable for the specific customer; and
initiating, by the application, based on the determination that the at least one recommended subscription plan is allowable for the specific customer, an action to provision the recommended at least one subscription plan to the specific subscriber.

18. The method of claim 17, wherein the one or more rules are based on at least one of:
a current subscription plan associated with the specific customer,
a previous subscription plan associated with the specific customer,
an organization associated with the specific customer, or
a frequency of recommendation.

19. The method of claim 17, further comprising:
adapting, by a second application stored in the non-transitory memory of the computer system and executable by the processor of the computer system, one or more parameters of at least one of the first model or the second model based on feedback associated with the recommended at least one subscription plan.

20. The method of claim 17, wherein:
the individual subscriber data further comprises user profile data associated with the specific subscriber,
the subscriber group data further comprises user profile data associated with respective ones of the plurality of subscribers, and
the analyzing the individual subscriber data against the subscriber group data further analyzes the user profile data associated with the specific subscriber against the user profile data associated with respective ones of the plurality of subscribers.
